(19) United States
(12) Patent Application Publication
(10) Pub. No.: US 2022/0139082 A1
(43) Pub. Date: May 5, 2022

(54) IMAGE PROCESSING DEVICE, IMAGE PROCESSING METHOD, AND PROGRAM

(71) Applicant: SONY GROUP CORPORATION, Tokyo (JP)

(72) Inventor: Yoichiro Sato, Tokyo (JP)

(21) Appl. No.: 17/433,752

(22) PCT Filed: Jan. 24, 2020
(86) PCT No.: PCT/JP2020/002536

§ 371 Date: Aug. 25, 2021

(30) Foreign Application Priority Data
Mar. 1, 2019 (JP) 2019-037208

(51) Int. Cl. G06V 20/10; G06T 7/70; G06T 3/40; G06V 20/17; G06V 10/98

(52) U.S. Cl. CPC G06V 20/188; G06T 7/70; G06T 3/4038; G06V 20/17; G06T 2207/10048; G06V 10/98; G06T 2207/30188; G06T 2207/10036; G06V 20/194

(57) ABSTRACT

Calculation of NDVI values with reduced errors caused by variations of sun-light reflection-vs-incidence angles is disclosed. One example of a device includes a data processor that retrieves an image captured by a camera and analyzes the retrieved image to calculate NDVI values indicating activity levels of a plant. The data processor selects plural sampling points from among constituent pixels of the retrieved image, calculates a sampling-point two-dimensional distribution approximation model formula that approximates a two-dimensional distribution of NDVI values and sun-light reflection-vs-incidence angles at the selected sampling points, generates, on the basis of the calculated sampling-point two-dimensional distribution approximation model formula, a corrected NDVI value calculation formula for calculating corrected NDVI values obtained by reducing variations of the NDVI values caused by variations of the sun-light reflection-vs-incidence angles, and calculates the corrected NDVI values according to the generated corrected NDVI value calculation formula.

### TECHNICAL FIELD

The present disclosure relates to an image processing device, an image processing method, and a program. More particularly, the present disclosure relates to as image processing device, an image processing method, and a program that perform plant activity-level determination based on images captured by a camera.

### BACKGROUND ART

There is a technology for photographing an aggregate of various kinds of plants such as agricultural crops, flowers, and trees by using a camera mounted in, for example, a drone or the like to analyze captured images and thereby measure activity levels of the plants.

As an index indicating an activity level of a plant, there is, for example, an NDVI (Normalized Difference Vegetation Index).

Analyzing the images captured by the camera and calculating the NDVI values of plants in the captured images enable estimation of activity levels of the plants in the captured images.

When images are captured by a camera mounted in, for example, a drone, however, the angle of the camera varies due to the shaking and flight-direction change of the drone, and thus, unevenness arises in the luminance and colors of a subject image inside a captured image, thereby causing a problem in that an accurate analysis cannot be performed.

As a conventional technology in which a technology for solving the above problem is disclosed, there is a technology disclosed in, for example, PTL 1 (PCT Patent Publication No. WO2016/181743).

In PTL 1, there is disclosed a configuration that enhances the accuracy of analysis by performing NDVI value correction taking into consideration the intensity of reflection light from a measurement target, such as an aggregate of leaves of a plant, and an angle of incidence of sun light to the measurement target.

The method described in PTL 1 employs a configuration in which the reflection-light intensity and the sun-light incidence angle at a time point when the camera captures one image are measured and an NTVI value is corrected in a unit of one image on the basis of resulting values of the measurement.

That is, a configuration in which similar correction processing is performed on all pixels included in one image is employed.

However, when images are captured from a high position by a camera mounted in, for example, a drone, a predetermined wide area is photographed in one captured image, and it follows that a sun-light incidence angle and the like relative to photographed subjects (plants) within the area differ according to each of positions of the photographed subjects.

The technology disclosed in PTL 1 does not employ a configuration in which the NDVI value is corrected in a unit of a region within one image, such as a unit of a pixel, and thus has a problem is that the accuracy of analysis degrades.

### CITATION LIST

### Patent Literature

[PTL 1]

PCT Patent Publication No. WO2016/181743

### SUMMARY

### Technical Problem

The present disclosure has been made in view of, for example, the above-described problem, and is intended to provide an image processing device, an image processing method, and a program that, in a configuration in which an activity level of a plant is determined on the basis of an image captured by a camera, correct activity index values such as NDVI values in a pixel unit of the image captured by the camera and make it possible to determine the activity level of the plant with high accuracy.

### Solution to Problem

According to a first aspect of the present disclosure, there is provided an image processing device including a data processing section that retrieves an image captured by a camera and analyzes the retrieved image including a constituent pixel unit, to calculate a vegetation index that is associated with the constituent pixel unit and indicates an activity level of a plant. The data processing section calculates, on the basis of a sun-light incidence angle associated with the constituent pixel unit, a corrected value associated with the vegetation index and obtained by reducing a variation of the vegetation index caused by a variation of a sun-light reflection-vs-incidence angle.

Further, according to a second aspect of the present disclosure, there is provided an image processing method performed by an image processing device including a data processing section that retrieves an image captured by a camera and analyzes the retrieved image including a constituent pixel unit, to calculate a vegetation index that is associated with the constituent pixel unit and indicates an activity level of a plant. The method causes the data processing section to calculate, on the basis of a sun-light incidence angle associated with the constituent pixel unit, a corrected value associated with the vegetation index and obtained by reducing a variation of the vegetation index caused by a variation of a sun-light reflection-vs-incidence angle.

Further, according to a third aspect of the present disclosure, there is provided a program that causes an image processing device to perform image processing. The image processing device includes a data processing section that retrieves an image captured by a camera and analyzes the retrieved image including a constituent pixel unit, to calculate a vegetation index that is associated with the constituent pixel unit and indicates an activity level of a plant. The program causes the data processing section to perform processing of calculating, on the basis of a sun-light incidence angle associated with the constituent pixel unit, a corrected value associated with the vegetation index and obtained by reducing a variation of the vegetation index caused by a variation of a sun-light reflection-vs-incidence angle.

Note that the program according to the present disclosure is a program that can be provided in a computer-readable form by a recording medium or a communication medium to, for example, an information processing device or a computer system that is capable of executing various kinds of program codes. By providing such a program in the computer-readable form, processing can be performed according to the program on the information processing device or the computer system.

Other objects, features, and advantages of the present disclosure will be made obvious by detailed description based on an embodiment of the present disclosure, which will be described later, and the accompanying drawings. Note that, in the present description, a system means a logically aggregated configuration of plural devices and is not limited to a configuration in which individually configured devices are housed in the same housing.

According to the configuration of an embodiment of the present disclosure, a device and a method that enable calculation of NDVI values in which errors caused by the variations of sun-light reflection-vs-incidence angles are reduced can be realized.

Specifically, the device includes, for example, a data processing section that retrieves an image captured by a camera and analyzes the retrieved image to calculate NDVI values indicating activity levels of a plant. The data processing section selects plural sampling points from among constituent pixels of the retrieved image, calculates a sampling-point two-dimensional distribution approximation model formula that approximates a two-dimensional distribution of NDVI values and sun-light reflection-vs-incidence angles at the selected sampling points, generates, on the basis of the calculated sampling-point two-dimensional distribution approximation model formula, a corrected NDVI value calculation formula for calculating corrected NDVI values obtained by reducing the variations of the NDVI values caused by the variations of the sun-light reflection-vs-incidence angles, and calculates the corrected NDVI values according to the generated corrected NDVI value calculation formula.

According to such a configuration, a device and a method that enable calculation of NDVI values is which errors caused by the variations of sun-light reflection-vs-incidence angles are reduced can be realized.

Note that effects described in the present description are just examples that do not limit the effects of the present disclosure, and there may be additional effects.

### BRIEF DESCRIPTION OF DRAWINGS

FIG. 1 illustrates diagrams that describe an NDVI image and a problem of the NDVI image.

FIG. 2 is a diagram that describes an NDVI image and a problem of the NDVI image.

FIG. 3 is a diagram that describes an example of image-capturing.

FIG. 4 is a diagram that describes a configuration of an image processing device according to the present disclosure and processing performed by the image processing device.

FIG. 5 is a diagram that describes an example of data stored is a memory 114 of as image-capturing/information acquisition section 110.

FIG. 6 is a flowchart that describes a processing sequence performed by a data processing section of the image processing device according to the present disclosure.

FIG. 7 is a diagram that describes processing performed by a sun position estimation section.

FIG. 8 is a diagram that describes a specific example of processing performed by a sun-light reflection-vs-incidence angle calculation section, for calculating a sun-light reflection-vs-incidence angle θsc associated with each constituent pixel of RED and NIR images.

FIG. 9 is a diagram that describes a specific example of combined image generation processing.

FIG. 10 is a flowchart that describes a detailed sequence of NDVI corrected value calculation processing that is associated with each pixel and takes into consideration a sun-light reflection-vs-incidence angle, the processing being performed by an NDVI correction section.

FIG. 11 illustrates diagrams that describe processing of selecting a sampling point (pixel) to be applied to the generation of a sampling-point two-dimensional distribution approximation model formula, and acquiring an NDVI value and a pixel-associated sun-light reflection-vs-incidence angle θsc that correspond to the selected sampling point.

FIG. 12 illustrates diagrams that describe examples of two-dimensional graphs which indicate NDVI values and reflection angles θ_{sc} and on which a distribution of NDVI values (NDVI (k, i, j)) and reflection-vs-incidence angles θ_{sc} (k, i, j) at plural sampling points is plotted.

FIG. 13 is a diagram that describes a specific example of the NDVI value correction processing performed by the NDVI correction section.

FIG. 14 illustrates diagrams that describe an NDVI corrected image having pixel values including NDVI corrected values generated by processing according to the present disclosure and a conventional NDVI image to which the processing according to the present disclosure is not applied.

FIG. 15 illustrates diagrams that describe an NDVI corrected image having pixel values including NDVI corrected values generated by processing according to the present disclosure and a conventional NDVI image to which the processing according to the present disclosure is not applied.

FIG. 16 is a diagram that describes a hardware configuration example of the image processing device according to the present disclosure.

### DESCRIPTION OF EMBODIMENT

Hereinafter, the details of an image processing device, an image processing method, and a program according to the present disclosure will be described referring to the drawings. It should be noted that the description will be gives according to the following items.

1. Outline of processing performed by image processing device according to present disclosure

2. NDVI as index indicating activity level of plant

3. Configuration of image processing device according to present disclosure and details of processing performed by image processing device

4. Details of NDVI value correction processing performed by NDVI correction section

5. Hardware configuration example of image processing device

6. Summary of configuration of present disclosure

### [1. Outline of Processing Performed by Image Processing Device According to Present Disclosure]

First, the outline of processing performed by the image processing device according to the present disclosure will be described.

As described above, there is a technology for photographing an aggregate of various kinds of plants such as agricultural crops, flowers, and trees by using a camera mounted in, for example, a drone or the like to analyze captured images and thereby measure activity levels of the plants.

As an index indicating an activity level of a plant (i.e., vegetation index), there is, for example, an NDVI (Normalized Difference Vegetation Index).

The NDVI has a characteristic that varies according to both a sun-light incidence angle relative to the plant and the orientation of a camera for measuring the NDVI, and such a characteristic behaves as a cause of an NDVI value error.

The image processing device according to the present disclosure is configured to acquire a relatively correct NDVI value in a unit of each of pixels included in an image having been captured by a camera mounted in, for example, a drone, by correcting a corresponding NDVI value error caused by both a sun-light incidence angle and the orientation of the camera at the time point of capturing the image.

Further, in the case where plural images spreading over a continuous area are captured by the camera, a combined image of a vast region can be generated by combining (stitching) the individual images. Even in the case where such image combining is performed, NDVI-value steps at image combining boundaries can be reduced by performing an NDVI value correction in a unit of each of pixels included in the individual images.

The key points of the processing performed by the image processing device according to the present disclosure are listed below.

(1) A sun position at an image-capturing time point is acquired from GPS time-of-day information at the image-capturing time point, and a captured image is projected on the earth's surface on the basis of the position and orientation of a camera at the image-capturing time point to calculate the sum of an incidence angle and a reflection angle of sun light (namely, a sun-light reflection-vs-incidence angle) for every projected pixel position.

(2) Two variables, namely, NDVI values and sun-light reflection-vs-incidence angles, are sampled to derive a model formula that approximates a two-dimensional distribution of the two variables at the sampling points.

(3) NDVI values of a retrieved image are relatively corrected by using a derived sampling-point two-dimensional distribution approximation model formula.

### [2. NDVI as Index Indicating Activity Level of Plant]

Next, the NDVI (Normalized Difference Vegetation Index), which is an index indicating an activity level of a plant, will be described.

In general, the NDVI can be calculated according to the following formula (Formula 1).

NDVI=(NIR−RED)/(NIR+RED) (Formula 1)

In the above formula (Formula 1), RED and NIR are the intensity (pixel value) of an RED wavelength (approximately 0.63 to 0.69 μm) and the intensity (pixel value) of an NIR wavelength (approximately 0.76 to 0.90 μm), respectively, at each of pixels of a pair of images having two wavelengths and having been measured by a multispectral camera capable of simultaneously capturing the pair of images.

The pixel values that represent the intensities of the RED and NIR wavelengths and are acquired from the pair of images having been captured by the multispectral camera are pixel values obtained by measuring reflection light from a photographed subject. Such reflection light can be represented by the following formulas (Formula 2a) and (Formula 2b), as the sum of diffuse reflection and specular reflection (mirror reflection).

NIR=NIR_{d}+NIRₛ (Formula 2a)

RED=RED_{d}+REDₛ (Formula 2b)

where NIR_{d} and RED_{d} are diffuse reflection elements, and NIRₛ and REDₛ are specular reflection (mirror reflection) elements.

A plant absorbs red wavelength light and photosynthesizes with chlorophyll, and light that the plant cannot absorb is emitted from its leaves as diffuse reflection. Thus, leaves that absorb a large amount of red wavelength light can be determined as leaves of a high activity level.

In order to correctly calculate the NDVI value, it is necessary to correctly measure the diffuse reflection elements (NIR_{d} and RED_{d}). However, the camera makes measurements in a state in which the specular reflection elements are added to the diffuse reflection elements, and thus, the specular reflection elements behave as noise to the NDVI.

Here, a formula that calculates a further highly accurate NDVI value by taking into consideration the individual elements of the diffuse reflection and the specular reflection and reducing the influence of the specular reflection elements (NIRs and REDs) that behave as noise is described below as a formula (Formula 3).

$$[ Math . 1 ]$$

$$NDVI = \frac{NIR - RED}{NIR + RED} = \frac{{NIR}_{d} - {RED}_{d} + {NIR}_{s} - {RED}_{s}}{{NIR}_{d} + {RED}_{d} + {NIR}_{s} + {RED}_{s}} \qquad ( Formula 3 )$$

Here, NIR_{d} and RED_{d} are a diffuse reflection element of the NIR wavelength (approximately 0.76 to 0.90 μm) and a diffuse reflection element of the RED wavelength (approximately 0.63 to 0.69 μm), respectively.

Further, NIRₛ and REDₛ are a specular reflection (mirror reflection) element of the NIR wavelength (approximately 0.76 to 0.90 μm) and a specular reflection (mirror reflection) element of the RED wavelength (approximately 0.63 to 0.69 μm), respectively.

For the NDVI value calculation formula indicated in the above formula (Formula 3), is the case where the specular reflection elements (NIRₛ and REDₛ) are large, the value of the numerator becomes small in comparison with that of the denominator. As a result, a calculated NDVI value becomes small. In the case where the leaves of a plant are assumed to be in clusters, in general, there is a tendency in which the smaller a sun-light incidence angle is, the larger a specular reflection element is. That is, when the plants are photographed from immediately above in a state is which the sun is due south, the specular reflection element measured by the multispectral camera becomes large, and the NVDI value becomes small.

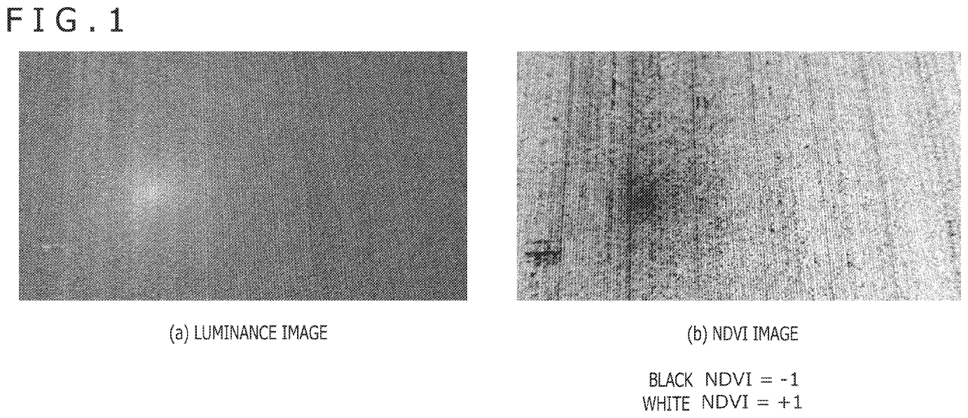

FIG. 1 illustrates an NDVI image in which NDVI value errors have arisen due to the influence of the specular reflection. FIG. 1 illustrates conditions obtained by photographing the same crops from the sky. In the FIG. 1, (a) is a luminance image, and (b) is an NDVI image obtained by setting NDVI values as pixel values.

(a) It is indicated that a bright portion around the lower left of the center of the luminance image is a portion brightened by the receipt of specular reflection of sun light.

(b) A corresponding region around the lower left of the center of the NDVI image is dark as compared with surrounding regions, and thus, it can be understood that the NDVI values of the region are small.

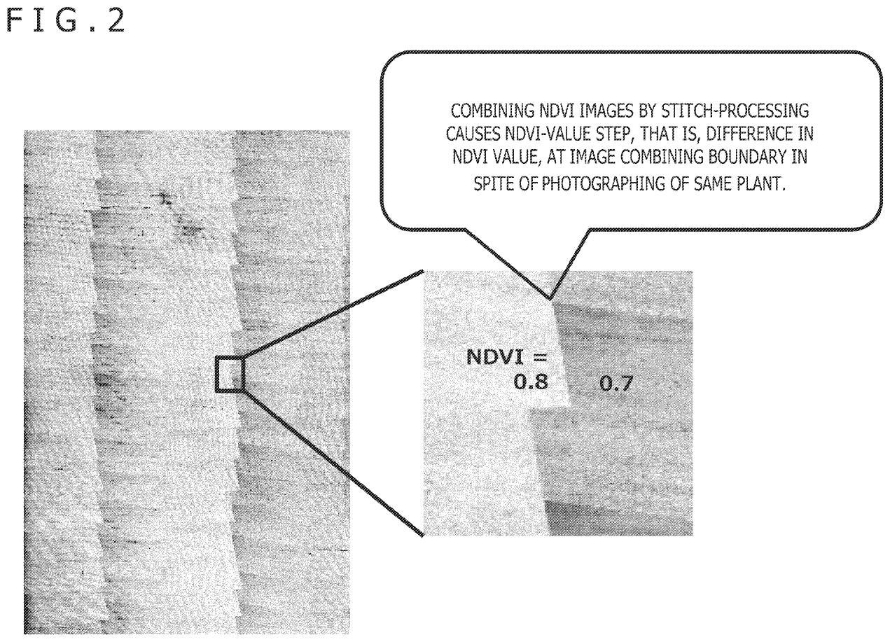

Further, performing stitch-processing (combining processing) for combining plural NDVI images in a state of including noise caused by the sun-light specular reflection element results in steps at image combining boundaries, as illustrated in FIG. 2.

When, for example, the activity levels of plants in a vast agricultural field are to be identified, the presence of the steps resulting from NDVI values different from actual plant activity levels causes a problem in that the states of the plants cannot be correctly grasped.

### [3. Configuration of Image Processing Device According to Present Disclosure and Details of Processing Performed by Image Processing Device]

Next, a configuration of the image processing device according to the present disclosure and the details of the processing will be described.

The image processing device according to the present disclosure acquires an image having been captured by a multispectral camera capable of simultaneously photographing the RED wavelength (visible light: approximately 0.63 to 0.69 μm) and the near-infrared NIR wavelength (approximately 0.76 to 0.90 μm), and calculates highly accurate plant activity index values, specifically, NDVI values.

The image processing device calculates further highly accurate NDVI values in a pixel unit of the captured image.

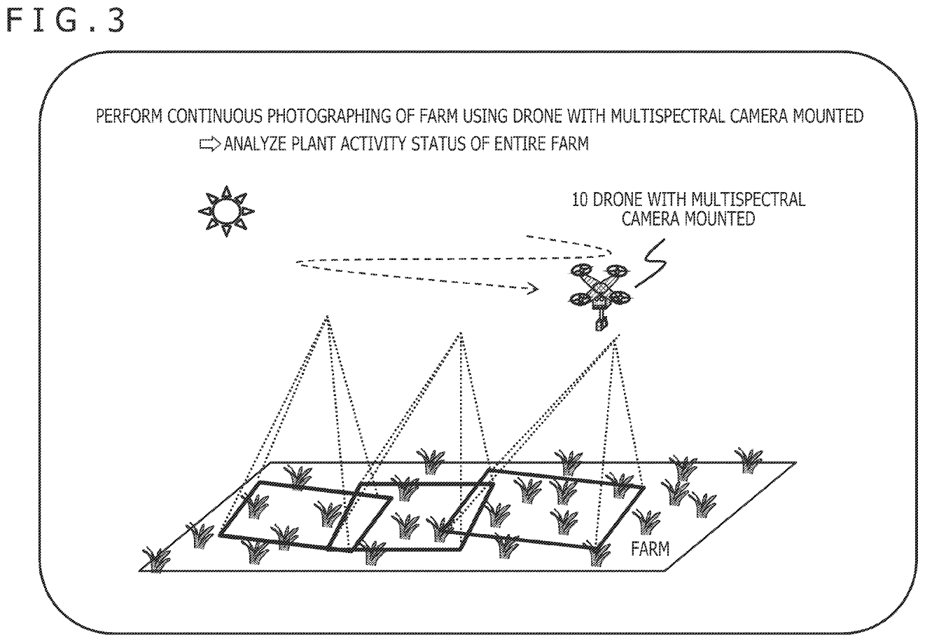

For example, as illustrated in FIG. 3, the processing according to the present disclosure can be used in an application or photographing the entire farm by using a drone mounting a multispectral camera capable of simultaneously photographing the RED wavelength and the NIR wavelength, to analyze the activity states of plants.

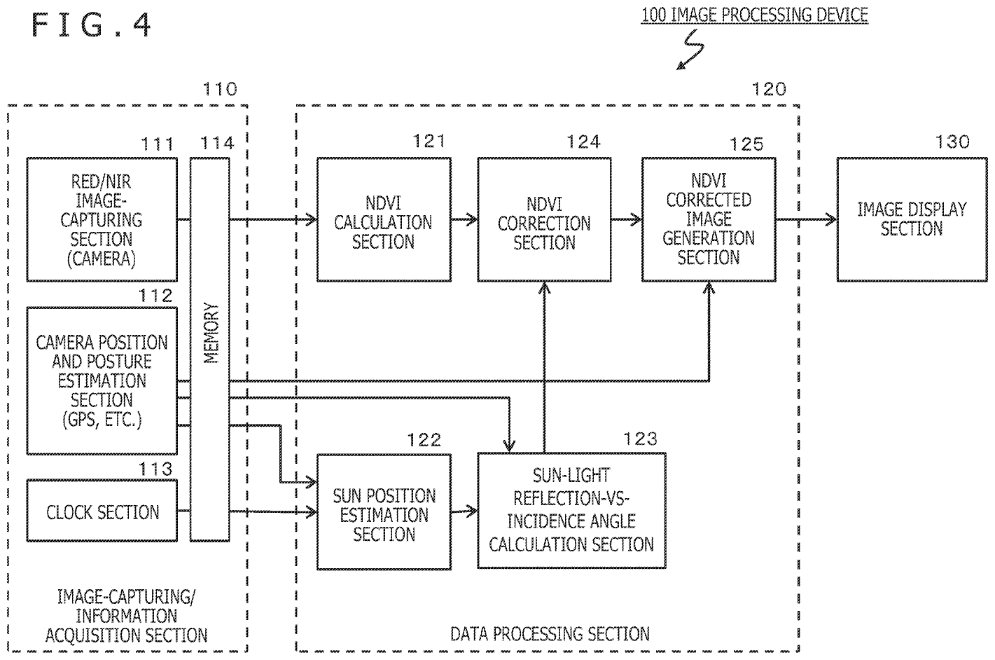

A configuration example of an image processing device 100 according to the present disclosure will be described. with reference to FIG. 4.

As illustrated in FIG. 4, the image processing device 100 includes an image-capturing/information acquisition section 110, a data processing section 120, and an image display section 130.

Note that the image-capturing/information acquisition section 110 which is a camera mounted in, for example, a drone or the like and the image display section 130 which is a display may be provided as external devices instead of being provided as constituent elements of the image processing device 100. In such a case, the image processing device 100 includes the data processing section 120 described below.

The data processing section 120 acquires an image, position information, and the like that have been acquired by the image-capturing/information acquisition section 110; calculates, on the basis of the acquired information, highly accurate NDVI values in a constituent pixel unit of the image having been acquired by the image-capturing/information acquisition section 110; generates an NDVI image by setting the calculated NDVI values as pixel values; and outputs the generated NDVI image to the image display section 130. Here, the constituent pixel unit of the image may be a unit of one pixel or a unit of plural pixels (for example, a matrix of two pixels×two pixels). In the case where the constituent pixel unit is the unit of plural pixels, for example, the average value of NDVI values having been calculated for individual pixels can be handled as an NDVI value serving as a representative value of the constituent pixel unit.

Note that, as a destination of the output of information generated by the data processing section 120, only the image display section 130 is illustrated in FIG. 4, but the configuration may be provided such that the information generated by the data processing section 120, such as the NDVI image, is recorded in, for example, a storage section.

The image-capturing/information acquisition section 110 includes a RED/NIR image-capturing section (camera) 111, a camera position and posture estimation section (GPS, etc.) 112, a clock section 113, and a memory 114.

The RED/NIR image-capturing section (camera) 111 a multispectral camera capable of simultaneously photographing light rays of two RED and NIR wavelengths. For example, the RED/NIR image-capturing section (camera) 111 photographs a farm successively while moving over the farm.

Captured images are stored in the memory 114.

The camera position and posture estimation section (GPS, etc.) 112 includes, for example, a GPS and a posture sensor, and measures the three-dimensional position of the image-capturing/information acquisition section 110, that is, the three-dimensional position of the RED/NIR image-capturing section (camera) 111. Specifically, a camera position “latitude, mild, and altitude” is measured with the GPS, and a rotation angle of a camera posture “roll, pitch, and yaw” is measured with the posture sensor.

Processing of measuring a camera three-dimensional position (position and posture) by the camera position and posture estimation section (GPS, etc.) 112 is continuously performed, and measured information is stored in the memory 114 as a time series of data.

The clock section 113 acquires time-of-day information at the time point of image-capturing and outputs the acquired time-of-day information to the memory 114.

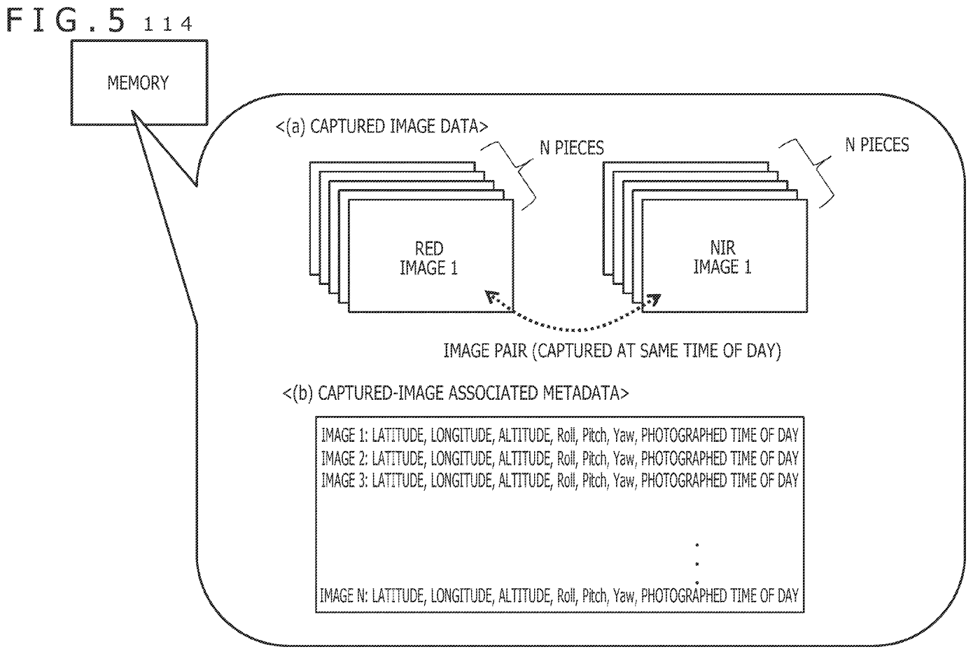

FIG. 5 is a diagram illustrating ac example of data stored in the memory 114 of the image-capturing/information acquisition section 110.

As illustrated in FIG. 5, the following two kinds of data are stored in the memory 114.

(a) Captured image data

(b) Captured image associated metadata

The (a) captured image data includes pairs of a RED image and an NIR image that are captured at the same time of day by the RED/NIR image-capturing section (camera) 111 while the drone is flying. Captured image data whose amount corresponds to the number of pairs (N pairs) of the captured images is stored.

The (b) captured image associated metadata is metadata for each of pairs of images which have been captured by the RED/NIR image-capturing section (camera) 111.

Data regarding “latitude, longitude, altitude, roll, pitch, yaw, and photographed time of day” associated with the camera at the time of day of capturing of a pair of a RED image and an NIR image is stored as the metadata.

In such a way, the following two kinds of data are stored in the memory 114 of the image-capturing/information acquisition section 110.

(a) Captured image data

(b) Captured image associated metadata

After the completion of the flight of the drone, the data processing section 120 retrieves the captured image data and metadata stored in the memory 114 and performs data processing based on the retrieved data, that is, data processing such as NDVI value calculation processing in a pixel unit.

Note that a configuration may be employed in which, during the flight of the drone, wireless communication between the image-capturing/information acquisition section 110 and the data processing section 120 is performed to transmit the above-described memory storage data, that is,

(a) captured image data, and

(b) captured image associated metadata,

to the data processing section 120 from the image-capturing/information acquisition section 110, and during the period of the flight of the drone, the data processing such as the NDVI value calculation processing in a pixel unit is performed on a real time basis.

Note that, in the case where such processing as described above is performed, the image-capturing/information acquisition section 110 and the data processing section 120 each include a communication section.

Next, a configuration of the data processing section 120 included in the image processing device 100 and illustrated in FIG. 4 and processing performed by the data processing section 120 will be described.

As illustrated in FIG. 4, the data processing section 120 includes an NDVI calculation section 121, a sun position estimation section 122, a sun-light reflection-vs-incidence angle calculation section 123, an NDVI correction section 124, and an NDVI image generation section 125.

The data processing section 120 acquires an image, position information, and the like that have been acquired by the image-capturing/information acquisition section 110; calculates, on the basis of the acquired information, a highly accurate NDVI value in a constituent pixel unit of the image having been acquired by the image-capturing/information acquisition section 110; generates an NDVI image by setting the calculated NDVI value as a pixel value; and outputs the generated NDVI image to the image display section 130.

Alternatively, as described above, processing of recording the information generated by the data processing section 120, such as the NDVI image, into the storage section is performed.

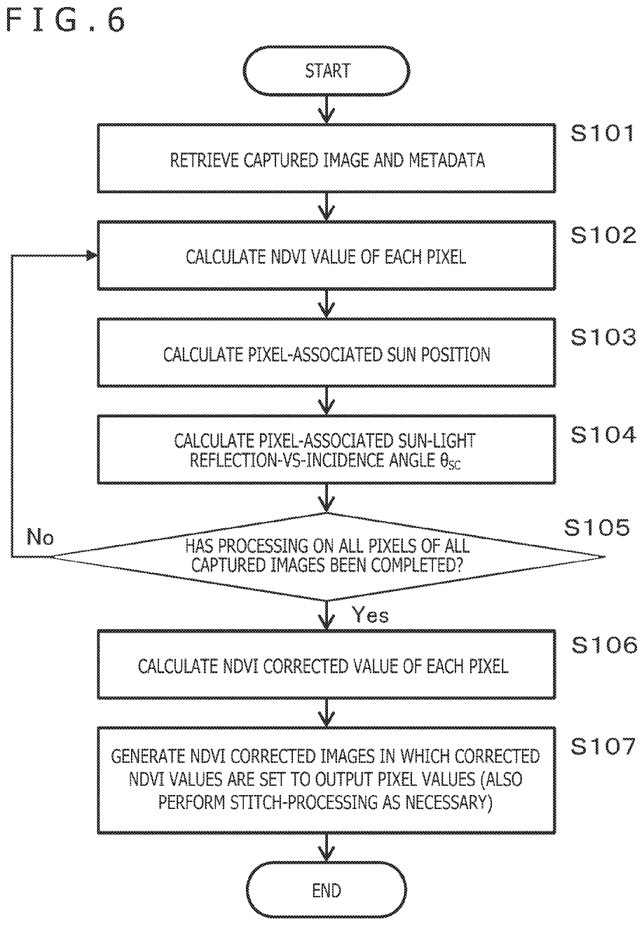

FIG. 6 illustrates a flowchart that describes a processing sequence performed by the data processing section 120.

According to the flowchart, a processing sequence performed by the data processing section 120 will be described. Note that processing according to the flowchart illustrated in FIG. 6 is executable according to a program stored in, for example, a storage section of the image processing device 100. The processing is executable under control of, for example, a data processing section (control section) including a CPU or the like having the function of executing a program.

Hereinafter, processing in each of steps of the flowchart illustrated in FIG. 6 will sequentially be described.

### (Step S101)

First, in step S101, the data processing section 120 retrieves captured images and metadata associated with the captured images.

As described above, the image-capturing/information acquisition section 110, which includes the multispectral camera mounted in, for example, a drone, photographs plants of a farm or the like from the sky at predetermined time intervals, and stores plural pairs of a RED image and an NIR image having mutually different wavelengths and metadata associated therewith, into the memory 114.

The data processing section 120 retrieves the pairs of images and the metadata.

As illustrated in FIG. 4, the plural pairs of the RED image and the NIR image that have been captured by the RED/NIR image-capturing section (camera) 111 of the image-capturing/information acquisition section 110 are input to the NDVI calculation section 121 of the data processing section 120.

Further, information regarding the camera three-dimensional position (position and posture) at the time point of image-capturing that has been estimated by the camera position and posture estimation section (GPS, etc.) 112 of the image-capturing/information acquisition section 110 is input to the sun position estimation section 122, the sun-light reflection-vs-incidence angle calculation section 123, and the NDVI corrected image generation section 125, which are included in the data processing section 120.

Further, the time-of-day information at the time point of image-capturing that has been measured by the clock section 113 is input to the sun position estimation section 122.

### (Step S102)

Next, in step S102, the data processing section 120 calculates NDVI values of individual pixels of each of the pairs of RED and NIR images having been captured by the RED/NIR image-capturing section (camera) 111 of the image-capturing/information acquisition section 110.

The processing is processing performed by the NDVI calculation section 121 included in the data processing section 120 and illustrated in FIG. 4.

The NDVI calculation section 121 sequentially acquires one pair of RED and NIR images having been captured at the same time of day, from the pairs of RED and NIR images, such as N pairs of RED and NIR images, which have been captured by the NIR image-capturing section (camera) 111. The NDVI calculation section 121 further acquires pixel values of corresponding pixels of the acquired one pair of RED and NIR images, to calculate NDVI values in a unit of each pixel.

Hereinafter, an NDVI value at a pixel position (X, Y)=(i, j) of an NDVI image having been captured at a time of day k will be denoted by NDVI (k, i, j).

The NDVI calculation section 121 calculates the NDVI values in a unit of each pixel according to the following formula (Formula 1), which is the same as the above-described formula (Formula 1).

NDVI=(NIR−RED)/(NIR+RED) (Formula 1)

In the above formula (Formula 1), RED and NIR are pixel values at positions of corresponding pixels of a pair of RED and NIR images having been captured by the RED/NIR image-capturing section (camera) 111 of the image-capturing/information acquisition section 110, that is, the intensities (pixel values) of the RED wavelength (approximately 0.63 to 0.69 μm) and the NIR wavelength (approximately 0.76 to 0.90 μm) at the corresponding pixels of the images having been captured by the multispectral camera.

Note that, when the above formula (Formula 1) is represented as a formula for calculating a NDVI value in a pixel unit, that is, NDVI (k, i, j) that is an NDVI value at a pixel position (X, Y)=(i, j) of an NDVI image having been captured at a time of day k, the above formula can be represented as the following formula (Formula 1a).

NDVI (k, i, j)=(NIR (k, i, j)−RED (k, i, j))/(NIR (k, i, j)+RED (k, i, j)) (Formula 1a)

### (Step S103)

Next, in step S103, the data processing section 120 calculates pixel-associated sun positions. That is, for the RED and NIR images having been captured by the RED/NIR image-capturing section (camera) 111 of the image-capturing/information acquisition section 110, sun positions at the time point of image-capturing are calculated. Note that the sun positions to be calculated are pixel-associated sun positions observed from individual constituent pixels included in the image.

The processing is processing performed by the sun position estimation section 122 included in the data processing section 120 and illustrated in FIG. 4.

The sun position estimation section 122 retrieves the information regarding the camera three-dimensional position (position and posture) at the time point of image-capturing that has been estimated by the camera position and posture estimation section (GPS, etc.) 112 of the image-capturing/information acquisition section 110 and the time-of-day information at the time point of image-capturing that has been measured by the clock section 113 and calculates, on the basis of the retrieved information, sun positions at the time point of image-capturing in the RED and NIR images having been captured by the RED/NIR image-capturing section (camera) 111 of the image-capturing/information acquisition section 110.

Note that the information regarding the camera three-dimensional position (position and posture) and the time-of-day information at the time point of image-capturing that has been measured by the clock section 113 are pieces of information set as meta-information regarding the RED and NIR images having been captured by the RED/NIR image-capturing section (camera) 111.

Information regarding the camera position and posture (latitude, longitude, altitude, roll, pitch, and yaw) at the time point of image-capturing and the photographed time-of-day information are associated, as the meta-information, with the RED and NIR images having been captured by the RED/NIR image-capturing section (camera) 111. The sun position estimation section 122 first determines a projected position of an NDVI image to be projected on the earth's surface, on the basis of the meta-information.

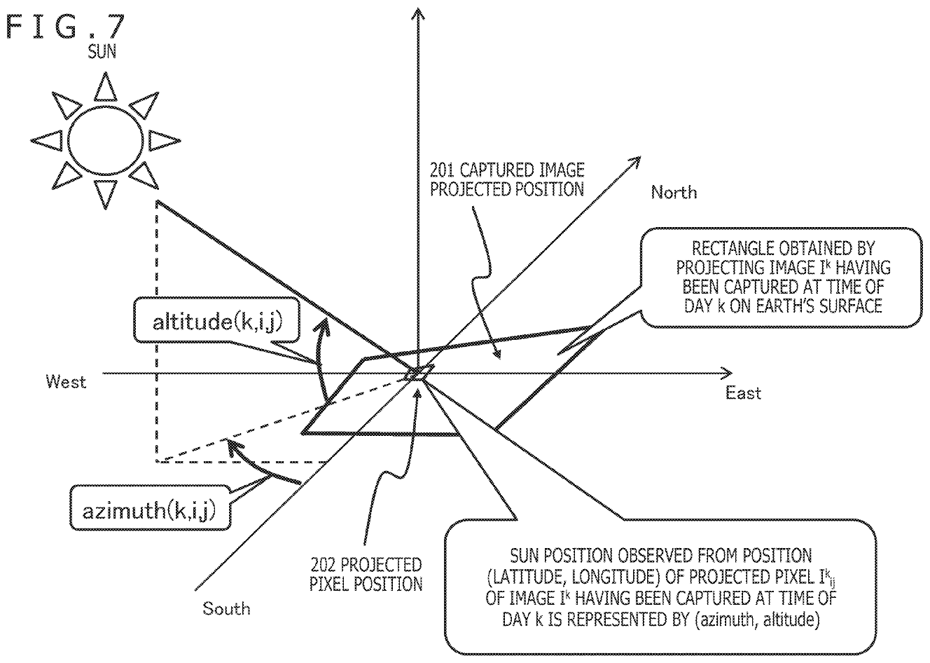

Processing performed by the sun position estimation section 122 will be described with reference to FIG. 7. As illustrated in FIG. 7, the sun position estimation section 122 first determines the projected position on the earth's surface with respect to the RED and NIR images having been captured by the RED/NIR image-capturing section (camera) 111, that is, a captured-image projected position 201 illustrated in FIG. 7, on the basis of the information regarding the camera position and posture (latitude, longitude, altitude, roll, pitch, and yaw) at the time point of image-capturing, which is the meta-information.

Through the processing of determining the captured-image projected position 201, every pixel position inside a captured image having been projected on the earth's surface can be represented by “latitude and longitude,” namely, a projected pixel position 202 illustrated in FIG. 7.

In the case where an NDVI image Ik having been captured at a time of day k is projected on the earth's surface, the position of a projected pixel Iᵢⱼk corresponding to a pixel position (X, Y)=(i, j) inside the NDVI image I is also determined by “latitude and longitude.”

Next, a specific example of sun position estimation processing performed by the sun position estimation section 122 will be described.

As illustrated in FIG. 7, the sun position estimation section 122 calculates a sun position (pixel-associated sun position) observed from the pixel position of the projected pixel Iᵢⱼk at the time of day k, as the following two kinds of angle information.

Sun's azimuth angle=azimuth (k, i, j)

Sun's altitude angle=altitude (k, i, j)

Note that (k, i, j) corresponds to (photographed time-of-day index, pixel X-position index, and pixel Y-position index).

Note that one of conventionally known methods is applicable to processing of calculating the sun's azimuth angle (azimuth) and the sun's altitude angle (altitude) that define a sun position, on the basis of input information, namely, the position (latitude and longitude) of a certain observation point on the earth and an observation time of day.

In such a way, the sun position estimation section 122 calculates the pixel-associated sun position, that is, a sun position observed from a projected position (=photographed-subject position) corresponding to each pixel Iᵢⱼk inside the captured image at the image-photographed time-point, namely, the time of day k.

### (Step S104)

Next, in step S104, the data processing section 120 calculates a pixel-associated sun-light reflection-vs-incidence angle θsc. That is, the data processing section 120 calculates a sun-light reflection-vs-incidence angle θsc associated with each of the constituent pixels of the RED and NIR images having been captured by the RED/NIR image-capturing section (camera) 111 of the image-capturing/information acquisition section 110.

The sun-light reflection-vs-incidence angle θsc is the sum of as incidence angle and a reflection angle of sun light relative to a photographed subject located at a photographed-subject position associated with each pixel.

The processing in step S104 is processing performed by the sun-light reflection-vs-incidence angle calculation section 123 included in the data processing section 120 and illustrated in FIG. 4.

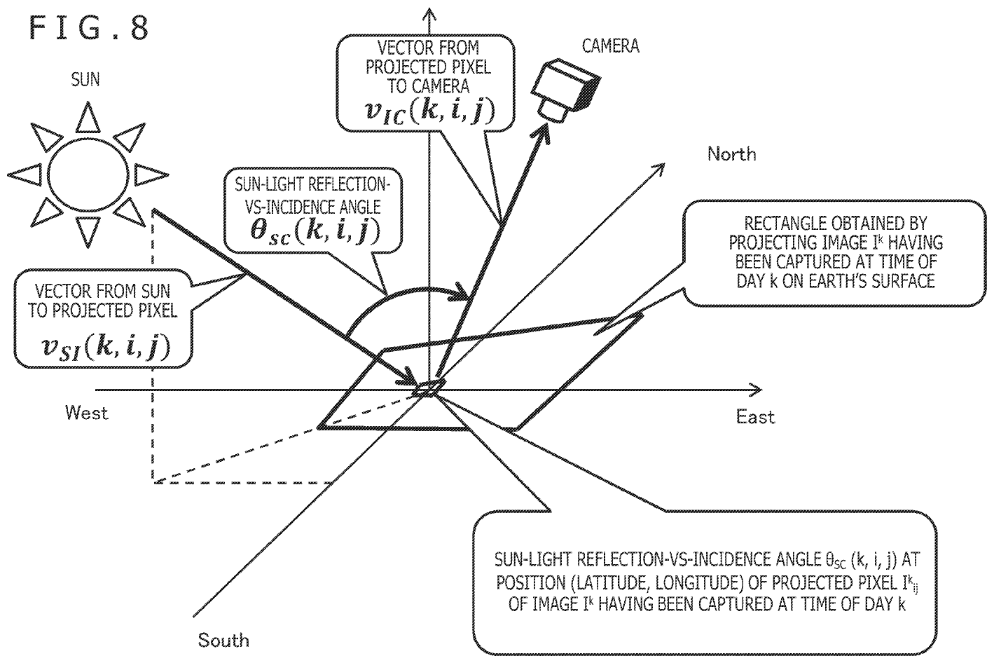

A specific example of the processing performed by the sun-light reflection-vs-incidence angle calculation section 123, for calculating the sun-light reflection-vs-incidence angle θsc associated with each of the constituent pixels of the RED and NIR images, will be described with reference to FIG. 8.

FIG. 8 illustrates a “sun-light reflection-vs-incidence angle θsc (k, i, j)” at a pixel position (i, j) of an image having been captured at a time of day k.

As illustrated in FIG. 8, a “sun-light reflection-vs-incidence angle θsc (k, i, j)” at a pixel position (i, j) of an image Ik having bees captured at a time of day k is defined as an angle formed by the following two vectors.

(a) “Vector v_{SI} (k, i, j) from the sun to a projected pixel”

(b) “Vector v_{IC} (k, i, j) from the projected pixel to the camera”

Here, regarding (a) “Vector v_{SI} (k, i, j) from the sun to a projected pixel,”

the vector can be calculated from the sun position (azimuth (k, i, j), altitude (k, i, j)) having been calculated is the sun position estimation processing in step S103.

In addition, regarding (b) “Vector v_{IC} (k, i, j) from the projected pixel to the camera,”

the vector can be calculated from the difference between the projected pixel position and camera position information (latitude, longitude, and altitude).

The sun-light reflection-vs-incidence angle θ_{sc} (k, i, j) can be calculated by using a formula (Formula 4) described later, from inner product of the following two vectors described above.

(a) “Vector v_{SI} (k, i, j) from the sun to a projected pixel”

(b) “vector v_{IC} (k, i, j) from the projected pixel to the camera”

Sun-light reflection-vs-incidence angle θ_{sc} (k, i, j)=arc cos (v_{SI} (k, i, j)·v_{IC} (k, i, j)) (Formula 4)

Through the above processing, the sun-light reflection-vs-incidence angle calculation section 123 calculates the sun-light reflection-vs-incidence angles θ_{sc} (k, i, j) associated with the individual pixels, with respect to all pixel positions of all images having been projected on the earth's surface.

### (Step S105)

Next, in step S105, the data processing section 120 determines whether or not the processing on all pixels of all of the RED and NIR images having been captured by the RED/NIR image-capturing section (camera) 111 of the image-capturing/information acquisition section 110 has been completed.

That is, the data processing section 120 determines whether or not the processing of calculating sun-light reflection-vs-incidence angles θ_{sc} (k, i, j) associated with all pixels of all of the captured images has been completed.

In the case where there remain one or more un-processed pixels, the processing returns to step S102, and the processing in steps S102 to S104 is performed on the one or more un-processed pixels.

In the case where it is determined that the processing of calculating the sun-light reflection-vs-incidence angles θ_{sc} (k, i, j) associated with all pixels of all of the images has been completed, the processing proceeds to step S106.

### (Step S106)

Next, in step S106, the data processing section 120 performs processing of correcting the NDVI values of the individual pixels.

That is, processing of correcting the NDVI values that are associated with the individual pixels and have been calculated by the NDVI calculation section 121 illustrated in FIG. 4 is performed.

The processing is processing performed by the NDVI correction section 124 included in the data processing section 120 and illustrated in FIG. 4.

As described above, in step S102 in the flowchart illustrated in FIG. 6, the NDVI calculation section 121 illustrated in FIG. 4 has calculated the NDVI values in a unit of each pixel according to the following formula (Formula 1).

NDVI=(NIR−RED)/(NIR+RED) (Formula 1)

The resulting calculated values, however, are values having been calculated without taking into consideration the sun-light reflection-vs-incidence angles associated with the individual pixels, and thus are values including errors.

As processing of eliminating the errors, the NDVI correction section 124 calculates NDVI corrected values that are associated with the individual pixels and have taken into consideration the sun-light reflection-vs-incidence angles associated with the individual pixels.

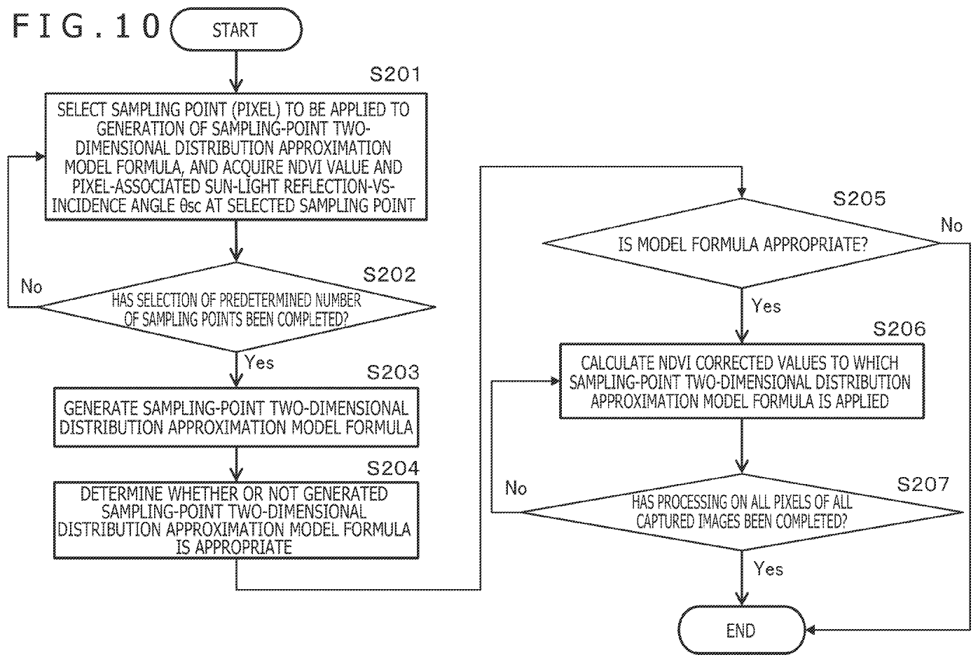

The details of the processing performed by the NDVI correction section 124, for calculating the NDVI corrected values that are associated with the individual pixels and have taken into consideration the sun-light reflection-vs-incidence angles, will be described later with reference to a flowchart of FIG. 10.

The NDVI correction section 124 calculates the NDVI corrected values that are associated with the individual pixels and have taken into consideration the sun-light reflection-vs-incidence angles, and outputs the calculated NDVI corrected values to the NDVI corrected image generation section 125.

### (Step S107)

Next, in step S107, the data processing section 120 generates NDVI corrected images in which the corrected NDVI values are set as output pixel values. Here, stitch-processing of combining plural NDVI corrected images is also performed, as necessary.

The above processing is processing performed by the NDVI corrected image generation section 125 included in the data processing section 120 and illustrated in FIG. 4.

The NDVI corrected image generation section 125 generates the NDVI corrected images, that is, images including the NDVI corrected values that the NDVI correction section 124 has calculated in step S106 described above.

Such NDVI corrected images have pixel values each including an NDVI corrected value that has been corrected in a unit of each pixel while a sun-light reflection-vs-incidence angle associated with each pixel is taken into consideration, and thus, the NDVI corrected image in which pixel values (NDVI corrected pixel values) indicating further highly accurate plant activity levels are set.

The NDVI corrected images having been generated by the NDVI corrected image generation section 125 are displayed on the image display section 130 illustrated in FIG. 4.

Further, the NDVI corrected images may be stored in the storage section of the image processing device 100, the storage section not being illustrated in FIG. 4.

Note that the NDVI corrected image generation section 125 also performs stitch-processing of combining plural NDVI corrected images, as necessary.

That is, one combined image is generated by performing the stitch-processing of combining the plural NDVI corrected images.

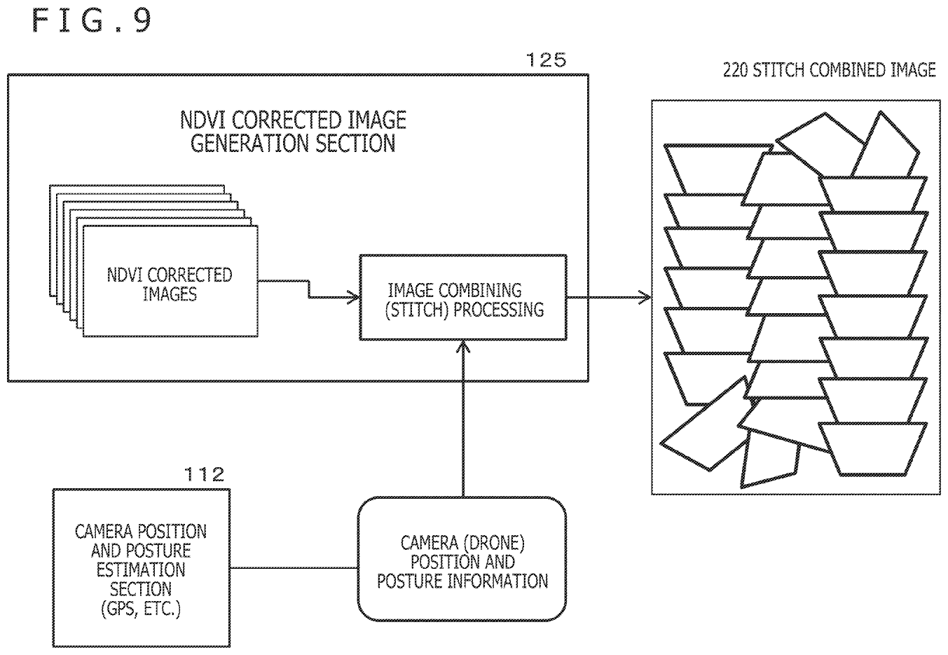

A specific example of the combined image generation processing will be described with reference to FIG. 9.

As illustrated in FIG. 9, the NDVI corrected image generation section 125 generates a number of images including the NDVI corrected values such that the number of the images correspond to the number of captured images. For example, the NDVI corrected image generation section 125 generates N pieces of NDVI corrected images corresponding to N pieces of continuously captured images.

Next, the stitch-processing of combining the plural images according to the projected positions of the individual images on the earth's surface (i.e., the positions of subjects as photographing targets) is performed.

Note that, as described above with reference to FIG. 7, the projected positions of the individual images on the earth's surface (the positions of subjects as photographing targets) can be calculated on the basis of the information regarding the camera position and posture (latitude, longitude, altitude, roll, pitch, and yaw) at the time point of image-capturing, which is the meta-information.

The NDVI corrected image generation section 125 performs the stitch-processing on the plural images to thereby generate a stitch combined image 220 corresponding to, for example, captured images of the whole of a vast farm.

The stitch combined image 220 having been generated by the NDVI corrected image generation section 125 is displayed on the image display section 130 illustrated in FIG. 4.

Further, the stitch combined image 220 may be stored in the storage section of the image processing device 100, the storage section not being illustrated in FIG. 4.

### [4. Details of NDVI Value Correction Processing Performed by NDVI Correction Section]

Next, the details of the NDVI value correction processing performed by the NDVI correction section 124 included in the data processing section 120 and illustrated in FIG. 4 will be described.

That is, the details of the processing in step S106 of the flowchart illustrated in FIG. 6 will be described.

The NDVI correction section 124 included in the data processing section 120 and illustrated in FIG. 4 performs processing of correcting the NDVI values that are associated with the individual pixels and have been calculated by the NDVI calculation section 121.

As described above, in step S102 in the flowchart illustrated in FIG. 6, the NDVI calculation section 121 calculates the NDVI values associated with the individual pixels, according to the following formula (Formula 1).

NDVI=(NIR−RED)/(NIR+RED) (Formula 1)

The resulting calculated values, however, are values having been calculated without taking into consideration the sun-light reflection-vs-incidence angles associated with the individual pixels, and thus are values including errors.

As processing of eliminating the errors, the NDVI correction section 124 calculates the NDVI corrected values that are associated with the individual pixels and have taken into consideration the sun-light reflection-vs-incidence angles associated with the individual pixels.

Hereinafter, the details of NDVI corrected value calculation processing that is associated with each pixel, takes into consideration the sun-light reflection-vs-incidence angles, and is performed by the NDVI correction section 124, will be described.

A flowchart illustrated in FIG. 10 is a flowchart for describing a detailed sequence of the NDVI corrected value calculation processing that is associated with each pixel, takes into consideration the sun-light reflection-vs-incidence angles, and is performed by the NDVI correction section 124.

Hereinafter, processing in each of steps of the flowchart will sequentially be described.

### (Step S201)

First, in step S201, the NDVI correction section 124 of the data processing section 120 selects a sampling point (pixel) to be applied to the generation of a sampling-point two-dimensional distribution approximation model formula, and acquires an NDVI value and a pixel-associated sun-light reflection-vs-incidence angle θsc at the selected sampling point.

The sampling point is selected from a NDVI image in which the NDVI values that are associated with individual pixels and have been calculated by the NDVI calculation section 121 on the basis of the captured images (RED and NIR images) having been captured at a time of day k are set as the pixel values.

Note that, as described above, an NDVI value at a pixel position (X, Y)=(i, j) in an NDVI image having been captured at a time of day k is represented by NDVI (k, i, j).

The pixel-associated sun-light reflection-vs-incidence angle θsc is a value calculated by the sun-light reflection-vs-incidence angle calculation section 123. As described above with reference to FIG. 8, a sun-light reflection-vs-incidence angle θsc at a pixel position (i, j) in an image having been captured at a time of day k is represented by θsc (k, i, j).

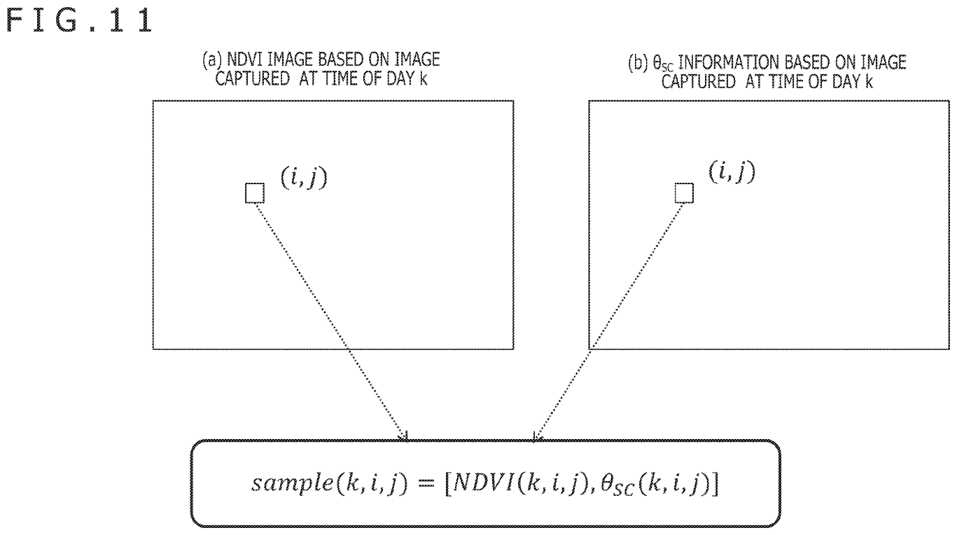

A specific example of the processing in step S201 will be described with reference to FIG. 11.

In step S201, the NDVI correction section 124 selects a sampling point (pixel) to be applied to the generation of the sampling-point two-dimensional distribution approximation model formula, and acquires an NDVI value and a pixel-associated sun-light reflection-vs-incidence angle θsc at the selected sampling point.

As illustrated in FIG. 11, the NDVI correction section 124 acquires, from a sampling point (pixel), two variables, namely, an NDVI value (NDVI (k, i, j)) and a reflection-vs-incidence angle θ_{sc} (k, i, j), at a constituent pixel (i, j) of the NDVI image.

The sampling point is acquired from a NDVI image having been generated from, for example, N pieces of images, that is, N pairs of captured images (RED and NIR images) having been captured during the same flight.

The number of the sampling points to be acquired is sufficient, provided that acquired sampling points enable generation of the sampling-point two-dimensional distribution approximation model formula in step S203.

In step S203, the sampling-point two-dimensional distribution approximation model formula is generated on the basis of individual pieces of data regarding NDVI values (NDVI (k, i, j)) and reflection-vs-incidence angles θ_{sc} (k, i, j) at plural sampling points.

That is, with respect to two pieces of data regarding the NDVI values (NDVI (k, i, j)) and the reflection-vs-incidence angles θ_{sc} (k, i, j) at the plural sampling points, the sampling-point two-dimensional distribution approximation model formula that indicates a distribution status of the NDVI values and the reflection-vs-incidence angles on a two dimensional plane is generated.

Such generation of the model formula is performed as processing of calculating a regression straight line (y=ax+b) on the basis of, for example, a least-square method. It is sufficient to acquire a number of sampling points which are enough to enable the calculation of the regression straight line (y=ax+b) based on the least-square method.

Specifically, with respect to, for example, data obtained by photographing a single kind of plant in flight, the number of the sampling points is preferably 1000 or more.

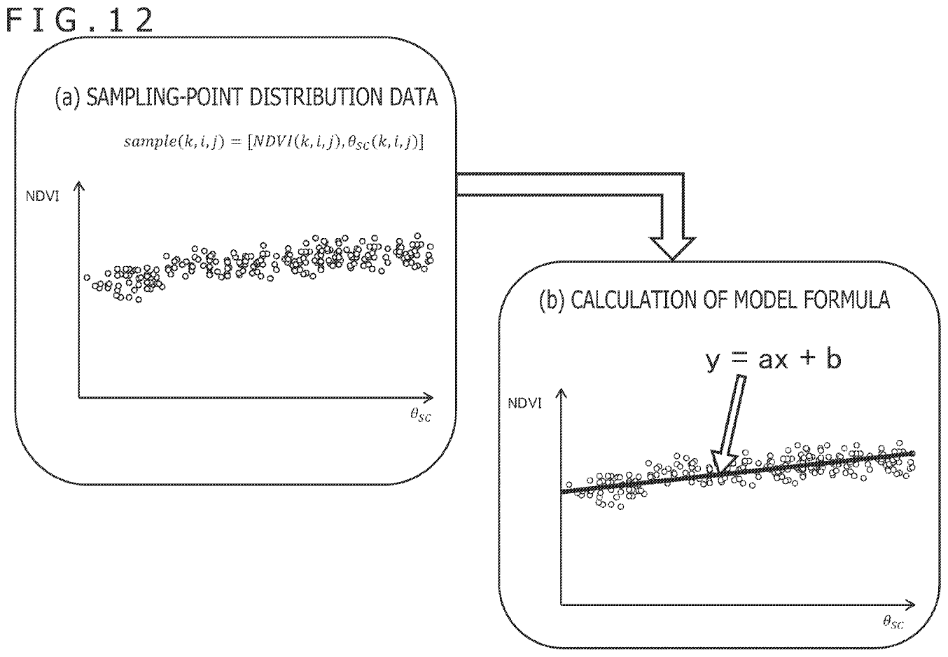

FIG. 12 illustrates an example of a two-dimensional graph which indicates NDVI values and reflection angles θ_{sc} and on which a distribution of NDVI values (NDVI (k i, j)) and reflection-vs-incidence angles θ_{sc} (k, i, j) at plural sampling points is plotted.

FIG. 12(a) illustrates distribution data regarding NDVI values (NDVI (k, i, j)) and reflection-vs-incidence angles θ_{sc} (k, i, j) at plural pixel-associated sampling points based on N pairs of images having been captured during certain flight.

The horizontal axis (x axis) indicates reflection-vs-incidence angles θ_{sc} (k, i, j) (=x), and the vertical axis (y axis) indicates NDVI values (NDVI (k, i, j)) (=y).

The sampling-point plots illustrated in FIG. 12(a) has an obliquely-right upward distribution.

This data indicates a tendency in which the larger the reflection-vs-incidence angle θ_{sc} (=x) is, the larger the NDVI value (=y) is.

This data is data that coincides with such a theory described above in which, in the case where the specular reflection element is large, that is, in the case where a plant is photographed from immediately above in a state in which the sun is due south, the specular reflection element measured by the multispectral camera becomes large, and the NDVI value becomes small.

In such a way, the NDVI image having been generated by the NDVI image generation section 121 is an NDVI image in which NDVI value errors have arisen due to the influence of the specular reflection, because the NDVI values associated with the individual pixels have been generated according to the following formula (Formula 1) described above.

NDVI=(NIR−RED)/(NIR+RED) (Formula 1)

The NDVI correction section 124 performs processing of calculating corrected NDVI values from which the errors are eliminated. That is, corrected NDVI values from which the influence of the specular reflection is eliminated and which cause the NDVI values (=y) to be constant regardless of the magnitudes of the reflection-vs-incidence angles θ_{sc} (=x) are calculated.

The sampling points are selected from the plural NDVI images. In such a case, the sampling points may randomly be acquired or may be acquired according to any rule.

Note that, for example, in the case where there are plural kinds of plants targeted for the calculation of the corrected NDVI values, a configuration may be employed in which the sampling and the generation of the sampling-point two-dimensional distribution approximation model formula are performed with respect to only an area of a specific kind of plant.

Performing processing associated with the kind of plant in such a manner enables calculation of highly accurate corrected NDVI values in a plant-kind unit. That is, a highly accurate activity-level determination in a plant-kind unit can be made.

In such a case, the NDVI correction section 124 of the data processing section 120 performs processing of calculating a sampling-point two-dimensional distribution approximation model formula that is associated with the kind of plant; generating, on the basis of the calculated sampling-point two-dimensional distribution approximation model formula that is associated with the kind of plant, a corrected NDVI value calculation formula that is associated with the kind of plant; and generating, on the basis of the generated corrected NDVI value calculation formula that is associated with the kind of plant, corrected NDVI values that are associated with the kind of plant.

### (Step S202)

As described above, in step S201, the NDVI correction section 124 of the data processing section 120 sequentially selects a sampling point (pixel) to be applied to the generation of the sampling-point two-dimensional distribution approximation model formula used for the NDVI correction, and acquires an NDVI value and a pixel-associated sun-light reflection-vs-incidence angle θsc at the selected sampling point.

In step S202, it is determined whether or not the number of the sampling points having been acquired in step S201 has reached a predetermined number.

The predetermined number is the number of sampling points that enable calculation of a regression straight line (y=ax+b) in step S203, and is a number having been determined in advance in step S201 at the posterior stage.

Note that, in the case where, as described above, the sampling-point two-dimensional distribution approximation model formula that is associated with the kind of plant is generated, a predetermined number of sampling points are selected in a plant-kind unit.

In the case where the acquisition of NDVI values and pixel-associated sun-light reflection-vs-incidence angles θsc at the sampling points whose total number is determined in advance has been completed, the processing proceeds to step S203; otherwise, the processing in step S201 is continued.

### (Step S203)

In the case where the acquisition of NDVI values and pixel-associated sun-light reflection-vs-incidence angles θsc at the sampling points whose total number is determined in advance has been completed, the processing proceeds to step S203.

In step S203, the NDVI correction section 124 generates the sampling-point two-dimensional distribution approximation model formula by using individual pieces of data regarding the NDVI values and the pixel-associated sun-light reflection-vs-incidence angles θsc at the sampling points the total number of which is determined in advance and which has been acquired in step S201.

Specifically, the NDVI correction section 124 generates a model formula that defines an association relation between NDVI values NDVI (k, i, j)) and reflection-vs-incidence angles θ_{sc} (k, i, j) at plural sampling points illustrated in FIG. 12(a).

As the model formula that defines the association relation between the NDVI values (NDVI (k, i, j)) and the reflection-vs-incidence angles θ_{sc} (k, i, j) at the sampling points, various model formulas are available. Here, as an example, a case is which a first-order equation that defines the association relation between the NDVI values (NDVI (k, i, j)) and the reflection-vs-incidence angles θ_{sc} (k, i, j) at the sampling points is used will be described.

With respect to the sampling points, y and x are defined as the following formulas.

y=NDVI values (NDVI (k, i, j))

x=reflection-vs-incidence angles θ_{sc} (k, i, j)

Further, the association relation between x and y is represented as the following formula (Formula 5).

y=ax+b (Formula 5)

where a and b are coefficients.

In step S203, the NDVI correction section 124 generates the first-order equation described in the above formula (Formula 5), as the sampling-point two-dimensional distribution approximation model formula.

In step S203, the NDVI correction section 124 calculates the coefficients “a” and “b” of the first-order equation described in the above formula (Formula 5) by using a least-square method.

An NDVI value and a reflection-vs-incidence angle θ_{sc} at a sampling point (i, j) of an image at a time of day k are presented as follows.

yₖᵢⱼ=NDVI value (NDVI (k, i, j))

xₖᵢⱼ=reflection-vs-incidence angle θ_{sc} (k, i, j)

That is, when the following formula is defined:

(xₖᵢⱼ, yₖᵢⱼ)=(θ_{sc} (k, i, j), NDVI (k, i, j)),

the coefficients “a” and “b” can be calculated by using a general method based on the least-square method for obtaining the regression straight line, according to the following formula (Formula 6).

$$[ Math . 2 ]$$

$$a = \frac{{Σ}_{kij} \{ ( {x}_{kij} - \overline{x} ) ( {y}_{kij} - \overline{y} ) \}}{{{Σ}_{kij} ( {x}_{kij} - \overline{x} )}^{2}} \\ b = \overline{y} - a \overline{x}$$

x̅: average value of xₖᵢⱼ

y̅: average value of yₖᵢⱼ (Formula 6)

The straight line illustrated in FIG. 12(b) is a straight line corresponding to the first-order equation y=ax+b using the coefficients “a” and “b” having been calculated according to the above formula (Formula 6).

As illustrated in FIG. 12(b), the straight line corresponding to the first-order equation y=ax+b becomes a formula (sampling-point two-dimensional distribution approximation model formula) obtained by approximating the aggregate of the sampling points with a straight line.

Note that, although an example of the derive of the model formula using the straight line has bees described here, the distribution of sampling points largely differs according to the kind and growing season of a plant to be photographed, and thus, it is also possible for a user to select a model formula capable of appropriately representing input samples. Specifically, a model formula to which processing of polynomial regression, logistic regression, or the like is applied can also be calculated.

### (Steps S204 to S205)

The NDVI correction section 124, which has generated the sampling-point two-dimensional distribution approximation model formula in step S203, subsequently determines, in steps S204 to S205, the appropriateness of the generated sampling-point two-dimensional distribution approximation model formula.

For example, in the case where the first-order equation described above in step S203, that is, the following first-order equation (Formula 5), is generated as the sampling-point two-dimensional distribution approximation model formula, the appropriateness of the model formula, which is the first-order equation, is determined.

y=ax+b (Formula 5)

where

y=NDVI value (NDVI (k, i, j)),

x=reflection-vs-incidence angle θ_{sc} (k, i, j), and

a and b are coefficients.

For the first-order equation described above as the formula (Formula 5), in the case where the coefficient “a” has a negative value, the larger the sun-light reflection-vs-incidence angle (x: reflection-vs-incidence angle θ_{sc}) is, the smaller y: NDVI value is.

This indicates that a model that conflicts with the existing theory “the NDVI value decreases with the increase of the influence of the specular reflection of sun light” has been generated.

In the case where, as described above, the coefficient “a” having bees calculated in step S203 has a negative value, it is determined that the sampling-point two-dimensional distribution approximation model formula has no appropriateness. In such a case, the determination in step S205 results in “No,” and the processing is ended without executing NDVI value correction processing which is to be performed in subsequent step S206 and beyond and to which the sampling-point two-dimensional distribution approximation model formula is applied.

Note that the criterion for the determination of the appropriateness of the sampling-point two-dimensional distribution approximation model formula in steps S204 and S205 is changed according to the model formula having been generated in step S203.

In contrast, in the case where the coefficient “a” having been calculated in step S203 has a positive value and where it is determined that a sampling-point two-dimensional distribution approximation model formula that coincides with the existing theory “the NDVI value decreases with the increase of the influence of the specular reflection of sun light” has been generated, the determination in step S205 results in “Yes,” and the NDVI value correction processing which is to be performed in subsequent step S206 and beyond and to which the sampling-point two-dimensional distribution approximation model formula is applied is performed.

### (Step S206)

In the case where it is determined in steps S204 and S205 that the sampling-point two-dimensional distribution approximation model formula having been generated in step S203 has appropriateness, the processing proceeds to step S206.

In step S206, the NDVI correction section 124 performs the NDVI value correction processing to which the sampling-point two-dimensional distribution approximation model formula having been generated in step S203 is applied.

In step S206, the NDVI correction section 124 corrects all of the pixel values (NDVI values) of the NDVI images that the NDVI calculation section 121 has generated, by using the following sampling-point two-dimensional distribution approximation model formula having been generated in step S203.

y=ax+b (Formula 5)

where

y=NDVI value (NDVI (k, i, j)),

x=reflection-vs-incidence angle θ_{sc} (k, i, j), and

a and b are coefficients.

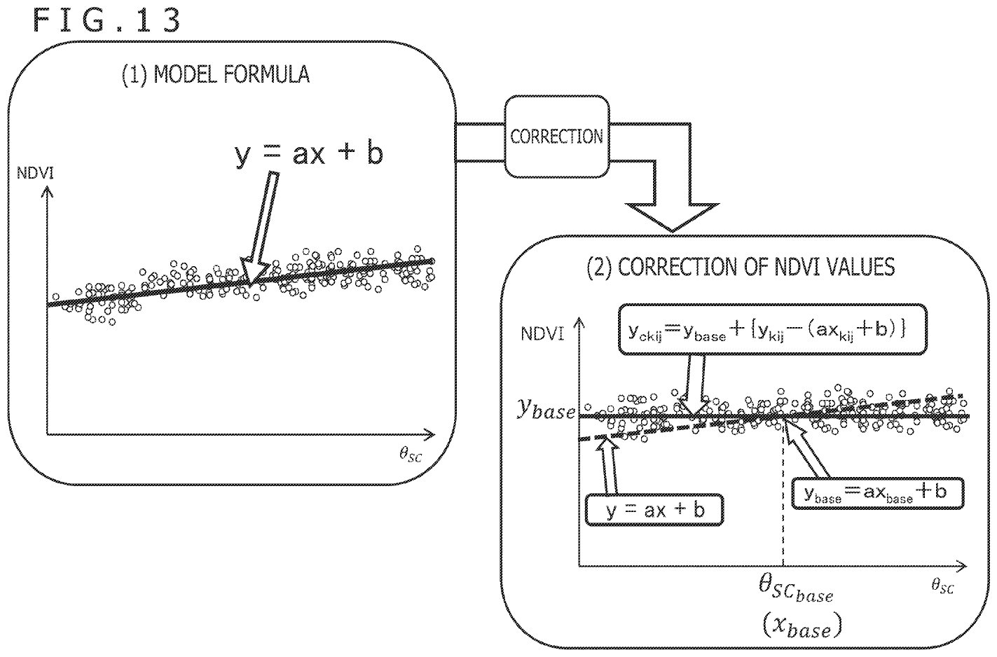

A specific example of the NDVI value correction processing performed by the NDVI correction section 124 in step S206 will be described with reference to FIG. 13.

First, the NDVI correction section 124 determines a reflection-vs-incidence angle that is to be a baseline of the correction, that is, x_{base}=θsc_{base}.

For the correction-baseline reflection-vs-incidence angle, a reflection-vs-incidence angle that causes NDVI noise resulting from the sun-light specular reflection to be sufficiently small is set. Specifically, it is sufficient to set a fixed value of, for example, approximately 45° as the correction-baseline reflection-vs-incidence angle (x_{base}).

Next, the NDVI correction section 124 sets:

an NDVI value at a pixel (i, j) of an NDVI image that is a target for the correction and is based on a captured image at a time of day k, as NDVI (k, i, j)=yₖᵢⱼ;

a sun-light reflection-vs-incidence angle at the same pixel, as θ_{sc} (k, i, j)=xₖᵢⱼ; and

a corrected NDVI value, as NDVIc (k, i, j)=y_{ckij}.

In such settings, the NDVI value at the pixel (i, j) of the NDVI image that is a target for the correction and is based on the captured image at the time of day k, that is, NDVI (k, i, j)=yₖᵢⱼ, and the sun-light reflection-vs-incidence angle at the same pixel, that is, θ_{sc} (k, i, j)=xₖᵢⱼ, are applied to the following sampling-point two-dimensional distribution approximation model formula, which has been generated in step S203.

y=ax+b (Formula 5)

Thus, a resulting first-order equation becomes the following formula.

yₖᵢⱼ=axₖᵢⱼ+b

The first-order equation is the sampling-point two-dimensional distribution approximation model formula illustrated in FIG. 13(1) and corresponds to a straight line represented by a dashed line in FIG. 13(2). The straight line represented by the dashed line is a first-order equation representing the distribution of the sampling points.

As described above, however, data associated with the association relation between the NDVI values and the sun-light reflection-vs-incidence angles and indicating the distribution of the sampling points corresponds to the relation formula having been generated on the basis of the NDVI image having been generated by the NDVI image generation section 121.

Since the NDVI image generation section 121 has calculated the NDVI values associated with the individual pixels according to the following formula (Formula 1) described above, the resulting NDVI image is an NDVI image in which NDVI value errors have arisen due to the influence of the specular reflection.

NDVI=(NIR−RED)/(NIR+RED) (Formula 1)

The NDVI correction section 124 performs processing of calculating corrected NDVI values from which the errors are eliminated. That is, the influence of the specular reflection is eliminated, and corrected NDVI values whose NDVI values (=y) become constant regardless of the magnitudes of the reflection-vs-incidence angles θ_{sc} (=x) are calculated.

In order to perform the above processing, the NDVI image generation section 121 first determines the following reflection-vs-incidence angle that becomes a baseline of the correction.

x_{base}=θsc_{base}

The angle is a correction-baseline reflection-vs-incidence angle (θsc_{base}32 x_{base}) illustrated on the horizontal axis (x axis) of the graph of FIG. 13(2).

Note that a correction-baseline NDVI value corresponding to the correction-baseline reflection-vs-incidence angle (θsc_{base}=x_{base}) is y_{base} that is represented by the following formula.

y_{base}=ax_{base}+b

Next, the NDVI correction section 124 generates corrected NDVI value calculation formula for calculating corrected NDVI values obtained by reducing the variations of the NDVI values caused by the variations of the sun-light reflection-vs-incidence angles.

That is, the NDVI correction section 124 generates a corrected NDVI value calculation formula that allows a relation represented by y=y_{base} to be satisfied regardless of the magnitudes of the reflection-vs-incidence angles θ_{sc} (=x).

The corrected NDVI value calculation formula to be generated is a formula for calculating corrected NDVI values, that is, the corrected NDVI values (y_{ckij}) represented by the following formula,

NDVIc (k, i, j)=y_{ckij}

on the basis of the NDVI values and the reflection-vs-incidence angles θ_{sc} at the sampling points (i, j) of the image at the time of day k, that is,

yₖᵢⱼ=NDVI value (NDVI (k, i, j)), and

xₖᵢⱼ=reflection-vs-incidence angle θ_{sc} (k, i, j).

The NDVI correction section 124 generates the corrected NDVI value calculation formula for calculating corrected NDVI values obtained by reducing the variations of the NDVI values caused by the variations of the sun-light reflection-vs-incidence angles.

That is, the NDVI correction section 124 generates the corrected NDVI value calculation formula that is represented by the following formula (Formula 7) and allows an approximately constant corrected NDVI value (y=y_{base}) to be calculated regardless of the magnitudes of the reflection-vs-incidence angles θ_{sc} (=x).

y_{ckij}=y_{base}+{yₖᵢⱼ−(axₖᵢⱼ+b)} (Formula 7)

In the above correction formula (Formula 7), {yₖᵢⱼ−(axₖᵢⱼ+b)}, which is a latter half part of the formula, corresponds to differences between the straight line (y=ax+b) that is represented by the dashed line in FIG. 13(2) and a straight line that is represented by the full line in FIG. 13(2) and is in parallel to the x axis. The straight line that is represented by the full line is represented by the following formula (Formula 7).

y_{ckij}=y_{base}+{yₖᵢⱼ−(axₖᵢⱼ+b)} (Formula 7)

When an NDVI value and a reflection-vs-incidence angle θ_{sc} at a sampling point (i, j) of an image at a time of day k, that is, yₖᵢⱼ=NDVI value (NDVI (k, i, j)) and xₖᵢⱼ=reflection-vs-incidence angle θ_{sc} (k, i, j), are input to the above formula (Formula 7), resulting values that satisfy the following relation for all of input values can be obtained.

y_{ckij}≈y_{base}

That is, the inclination for the sampling points caused by the specular reflection can be corrected so as to be flat while the differences between the sampling-point two-dimensional distribution approximation model formula and actual NDVI values are retained.

### (Step S207)

Last, in step S207, the NDVI correction section 124 determines whether or not processing of calculating corrected NDVI values corresponding to all pixels of all of the captured images has been completed.

In the case where there is one or more un-processed images, the processing returns to step S206, and corrected NDVI values of un-processed pixels are calculated.

In the case where it is determined in step S207 that the processing of calculating the corrected NDVI values corresponding to all pixels of all of the captured images has been completed, the processing is ended.

In such a way, the NDVI correction section 124 calculates the NDVI corrected values that are associated with the individual pixels and have taken into consideration the sun-light reflection-vs-incidence angles, and outputs the calculated NDVI corrected values to the NDVI corrected image generation section 125.

The NDVI corrected image generation section 125 generates an NDVI corrected image in which the corrected NDVI values have been set as output pixel values. Note that the stitch-processing of combining plural NDVI corrected images is also performed, as necessary.

The NDVI corrected image has pixel values including the NDVI corrected values that are corrected in a unit of each pixel while sun-light reflection-vs-incidence angles that are associated with individual pixels are taken into consideration, and thus becomes an image in which pixel values (NDVI corrected pixel values) indicating further highly accurate plant activity levels are set.

The NDVI corrected image having been generated by the NDVI corrected image generation section 125 is displayed on the image display section 130 illustrated in FIG. 4.

Further, the NDVI corrected image may be stored in the storage section of the image processing device 100, the storage section not being illustrated in FIG. 4.

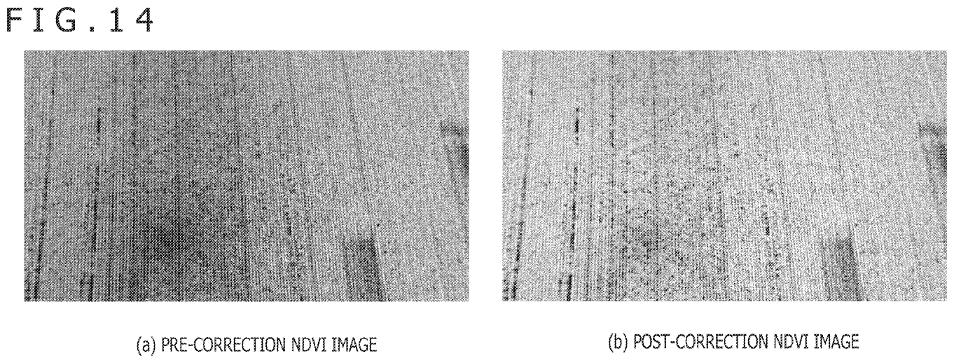

An example of the comparison between an NDVI corrected image having pixel values including NDVI corrected values generated by the processing according to the present disclosure and a conventional NDVI image to which the processing according to the present disclosure is not applied is illustrated in FIG. 14. FIG. 14 illustrates the following two NDVI images.

(a) Pre-correction NDVI image

(b) Post-correction NDVI image

The (a) pre-correction NDVI image is an NDVI image on which the correction processing according to the present invention is not performed. That is, the (a) pre-correction NDVI image is an image in which NDVI values calculated by the NDV1 calculation section 121 according to the following formula (Formula 1) described above are set as pixel values.

NDVI=(NIR−RED)/(NIR+RED) (Formula 1)

That is, the (a) pre-correction NDVI image is an NDVI image in which NDVI value errors have arisen due to the influence of the specular reflection. A region located at the lower left of the center of the image is dark as compared with surrounding regions, and the region is a region in which a large amount of noise caused by the sun-light specular reflection element exists and which has small NDVI values.

The (b) post-correction NDVI image is an NDVI corrected image on which the correction processing according to the present disclosure has been performed. In such an image, a region located at the lower left of the center of the image is not dark as compared with surrounding regions. The region is a region in which a large amount of noise caused by the sun-light specular reflection element exists, but the NDVI values have been corrected into values almost similar to those of the surrounding regions by the NDVI value correction processing according to the present disclosure.

That is, the image illustrated in FIG. 14(b) is an image in which the corrected NDVI values having been calculated according to the following formula (Formula 7) described above are set.

y_{ckij}=y_{base}+{yₖᵢⱼ−(axₖᵢⱼ+b)} (Formula 7)

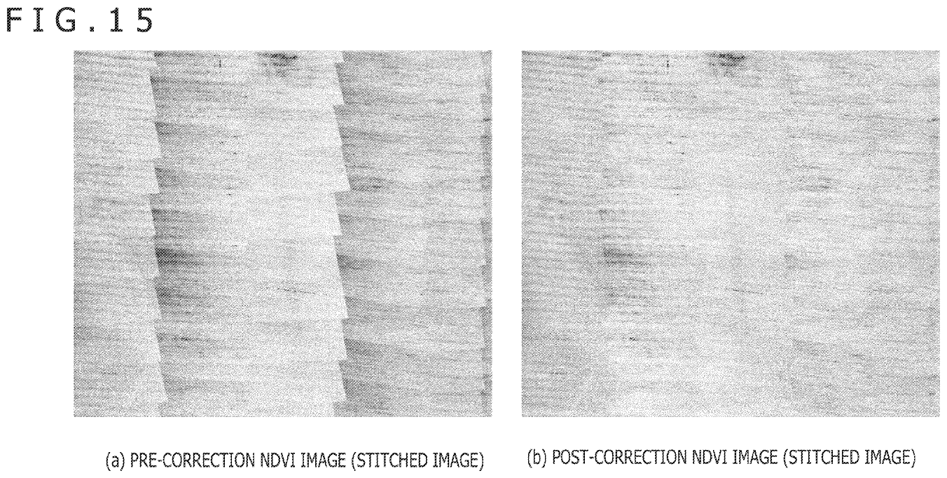

Further, an example of the stitched image will be described with reference to FIG. 15. FIG. 15 illustrates the following two NDVI images.

(a) Pre-correction NDVI image (stitched image)

(b) Post-correction NDVI image (stitched image)

Both of the above images are stitched images obtained by combining plural NDVI images.

The (a) pre-correction NDVI image (stitched image) is a stitched image (combined image) based on NDVI images on which the correction processing according to the present invention is not performed. That is, the (a) pre-correction NDVI image is a combined image obtained by combining plural images in which the NDVI values calculated by the NDVI calculation section 121 according to the following formula (Formula 1) described above are set as pixel values.

NDVI=(NIR−RED)/(NIR+RED) (Formula 1)

The steps are clearly visible at the image boundaries of the combined image. This is because the NDVI values of each of the images have errors.

The (b) post-correction NDVI image (stitched image) is a stitched image (combined image) based on NDVI corrected images on which the correction processing according to the present disclosure has been performed. The image boundaries of the combined image become smooth boundaries at which the steps are almost eliminated. This is because correct NDVI values are set by the NDVI value correction processing according to the present disclosure.

### [5. Hardware Configuration Example of Image Processing Device]

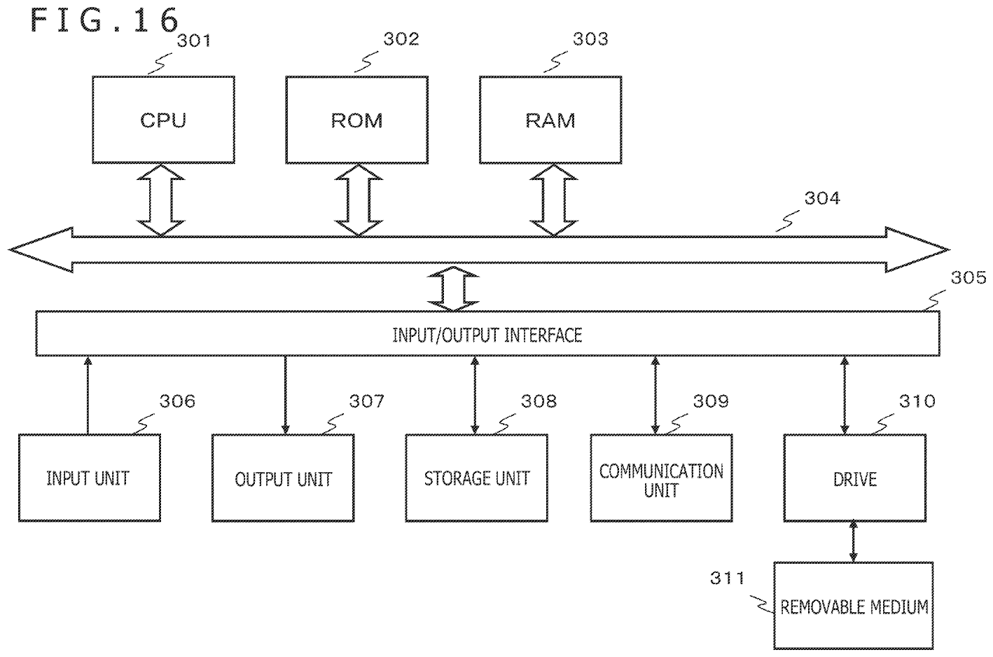

Next, a hardware configuration example of the image processing device according to the present disclosure will be described with reference to FIG. 16. The hardware illustrated in FIG. 16 is a configuration example of specific hardware of the image processing device according to the present disclosure.

A CPU (Central Processing Unit) 301 functions as a control unit or a data processing unit that performs various kinds of processing according to a program stored in a ROM (Read Only Memory) 302 or a storage unit 308. For example, the CPU 301 performs processing according to the sequence having been described in the above-described embodiment. A RAM (Random Access Memory) 303 stores therein. the program and related data that are executed by the CPU 301. The CPU 301, the ROM 302, and the RAM 303 are connected to each other via a bus 304.

The CPU 301 is connected to an input/output interface 305 via the bus 304, and the input/output interface 305 is connected to an input unit 306 including various kinds of switches, a keyboard, a mouse device, a microphone, a sensor, and other input components, and an output unit 307 including a display, a speaker, and other output components.

The CPU 301 performs various kinds of processing in response to instructions input from the input unit 306, and outputs processing results to, for example, the output unit 307.

The storage unit 308 connected to the input/output interface 305 includes, for example, a hard disk and the like, and stores therein the program and various kinds of data that are executed by the CPU 301. A communication unit 309 functions as a transmitting/receiving unit for Wi-Fi communication, Bluetooth (registered trademark) (BT) communication, and any other data communication via a network such as the Internet or a local area network, and communicates with external devices.

A drive 310 connected to the input/output interface 305 drives a removable medium 311 including, for example, a magnetic disk, an optical disk, an opto-magnetic disk, and a semiconductor memory such as a memory card, to perform recording/reading of data.

### [6. Summary of Configuration of Present Disclosure]

Heretofore, as embodiment of the present disclosure has been described in detail referring to the specific embodiment. It is obvious, however, that those skilled in the art may achieve modifications and substitutions of the embodiment within the scope not departing the gist of the present disclosure. That is, the present invention has been disclosed in the form of an example, and thus, should not be interpreted in a limited manner. In order to grasp the gist of the present disclosure, the section of claims in the present description should be taken into consideration.

It should be noted that the technology having been disclosed is the present description can have the following configurations.
(1)

An image processing device including:

a data processing section that retrieves an image captured by a camera and analyzes the retrieved image including a constituent pixel unit, to calculate a vegetation index that is associated with the constituent pixel unit and indicates an activity level of a plant,

in which the data processing section calculates, on the basis of a son-light incidence angle associated with the constituent pixel unit, a corrected value associated with the vegetation index and obtained by reducing a variation of the vegetation index caused by a variation of a sun-light reflection-vs-incidence angle.
(2)

The image processing device according to (1), in which the vegetation index includes an NDVI (Normalized Difference Vegetation index) value.
(3)

The image processing device according to (2),

in which the retrieved image includes plural constituent pixel units, and

the data processing section
selects plural sampling points from among the plural constituent pixel units of the retrieved image to calculate a sampling-point two-dimensional distribution approximation model formula that approximates a two-dimensional distribution of NDVI values and sun-light reflection-vs-incidence angles at the selected. sampling points,
generates, on the basis of the calculated sampling-point two-dimensional distribution approximation model formula, a corrected NDVI value calculation formula for calculating corrected values obtained by reducing variations of the NDVI values caused by variations of the sun-light reflection-vs-incidence angles, and
calculates the corrected values according to the generated corrected NDVI value calculation formula.
(4)

The image processing device according to any one of (1) to (3),

in which the data processing section includes
a sun position estimation section that estimates a sun position at a time point of capturing the image, and
a sun-light reflection-vs-incidence angle calculation section that calculates a sun-light reflection-vs-incidence angle θsc associated with the constituent pixel unit of the image captured by the camera, by using the sun position estimated by the sun position estimation section.
(5)

The image processing device according to any one of (1) to (4), is which the sun-light reflection-vs-incidence angle calculation section calculates, as the sun-light reflection-vs-incidence angle θsc, a sum of an incidence angle and a reflection angle of sun light relative to a photographed subject associated with a constituent pixel of the image captured by the camera.
(6)

The image processing device according to any one of (1) to (5),

in which the data processing section includes
an NDVI calculation section that, without taking into consideration the sunlight reflection-vs-incidence angle, analyzes the image captured by the camera, to calculate the NDVI value, and generates an NDVI image by setting the NDVI value to individual pixels, and
an NDVI correction section that retrieves the NDVI image generated by the NDVI calculation section and calculates, on the basis of the sampling-point two-dimensional distribution approximation model formula, a corrected NDVI value obtained by reducing a variation of the NDVI value caused by the variation of the sun-light reflection-vs-incidence angle.
(7)

The image processing device according to any one of (1) to (6), in which the data processing section calculates, as the sampling-point two-dimensional distribution approximation model formula, a first-order equation that approximates the two-dimensional distribution of the NDVI values and the sun-light reflection-vs-incidence angles at the sampling points.
(8)

The image processing device according to (7), in which the data processing section calculates coefficients of the first-order equation by using a regression straight line calculation method to which a least-square method is applied.
(9)

The image processing device according to (2) to (8), in which the data processing section further includes an NDVI corrected image generation section that generates an NDVI corrected image including the corrected value.
(10)

The image processing device according to (9), in which the NDVI corrected image generation section generates a combined image by performing stitch-processing on plural NDVI corrected images.
(11)

The image processing device according to any one of (2) to (10), in which the data processing section selects plural sampling points from among constituent pixels of plural images captured at mutually different timings and calculates the sampling-point two-dimensional distribution approximation model formula that approximates the two-dimensional distribution of the NDVI values and the sun-light reflection-vs-incidence angles at the selected sampling points.
(12)

The image processing device according to any one of (2) to (11),

in which the data processing section
determines whether or not the calculated sampling-point two-dimensional distribution approximation model formula is appropriate,
generates, on condition that it is determined that the calculated sampling-point two-dimensional distribution approximation model formula is appropriate, the corrected NDVI value calculation formula for calculating the corrected values obtained by reducing the variations of the NDVI values caused by the variations of the sun-light reflection-vs-incidence angles, on the basis of the calculated sampling-point two-dimensional distribution approximation model formula, and
calculates the corrected values according to the generated corrected NDVI value calculation formula.
(13)

The image processing device according to (12), in which the data processing section performs, as processing of determining whether or not the calculated sampling-point two-dimensional distribution approximation model formula is appropriate, processing of determining whether or not the calculated sampling-point two-dimensional distribution approximation model formula coincides with an existing theory indicating that the NDVI values decrease as influences of sun-light specular reflection increase.
(14)

The image processing device according to any one of (2) to (13),

in which the data processing section
calculates the sampling-point two-dimensional distribution approximation model formula associated with a kind of plant,
generates, on the basis of the calculated sampling-point two-dimensional distribution approximation model formula associated with the kind of plant, a corrected NDVI value calculation formula associated with the kind of plant, and
calculates a corrected value associated with the kind of plant according to the generated corrected NDVI value calculation formula associated with the kind of plant.
(15)

The image processing device according to any one of (1) to (14), in which the image captured by the camera includes an image captured by a multispectral camera capable of simultaneously capturing two images having mutually different wavelengths that include a RED wavelength (approximately 0.63 to 0.69 μm) and an NIR wavelength (approximately 0.76 to 0.90 μm).
(16)

The image processing device according to any one of (1) to (15), in which the image captured by the camera includes an image captured from sky.
(17)

An image processing method performed by an image processing device including a data processing section that retrieves an image captured by a camera and analyzes the retrieved image including a constituent pixel unit, to calculate a vegetation index that is associated with the constituent pixel unit and indicates an activity level of a plant, the method including:

causing the data processing section to calculate, on the basis of a sun-light incidence angle associated with the constituent pixel unit, a corrected value associated with the vegetation index and obtained by reducing a variation of the vegetation index caused by a variation of a sun-light reflection-vs-incidence angle.
(18)

A program that causes an image processing device to perform image processing, the image processing device including a data processing section that retrieves an image captured by a camera and analyzes the retrieved image including a constituent pixel unit, to calculate a vegetation index that is associated with the constituent pixel unit and indicates an activity level of a plant, the program causing the data processing section to perform:

processing of calculating, on the basis of a sun-light incidence angle associated with the constituent pixel unit, a corrected value associated with the vegetation index and obtained by reducing a variation of the vegetation index caused by a variation of a sun-light reflection-vs-incidence angle.

Further, the series of processing having been described in the present description can be executed by hardware, software, or a composite configuration of both the hardware and the software. In the case where the processing is executed by the software, a configuration that allows a program recording therein a processing sequence to be installed into a memory inside a computer embedded in dedicated hardware and be executed, or a configuration that allows the program to be installed into a general-purpose computer capable of executing various kinds of processing and be executed can be employed. For example, the program can be recorded in a recording medium in advance. In addition to a configuration that allows the program to be installed into the computer from the recording medium, a configuration that allows the program to be received via a network such as a LAN (Local Area Network) or the Internet and allows the received program to be installed into an incorporated recording medium such as a hard disk can also be employed.

Note that the various kinds of processing described in the present description may be executed not only in time series according to the described sequence, but also in parallel or individually according to the processing power of a device that executes the processing, or when needed. Further, in the present description, the system means a logically aggregated configuration of plural devices, and is not limited to a configuration in which individually configured devices are housed in the same housing.

### INDUSTRIAL APPLICABILITY

As described above, the configuration of the embodiment of the present disclosure realizes a device and a method that enable calculation of NDVI values in which errors caused by the variations of sun-light reflection-vs-incidence angles are reduced.

Specifically, the device, for example, includes a data processing section that retrieves an image captured by a camera and analyzes the retrieved image to calculate NDVI values indicating activity levels of a plant. The data processing section selects plural sampling points from among constituent pixels of the retrieved image, calculates a sampling-point two-dimensional distribution approximation model formula that approximates a two-dimensional distribution of NDVI values and sun-light reflection-vs-incidence angles at the selected sampling points, generates, on the basis of the calculated sampling-point two-dimensional distribution approximation model formula, a corrected NDVI value calculation formula for calculating corrected NDVI values obtained by reducing the variations of the NDVI values caused by the variations of the sun-light reflection-vs-incidence angles, and calculates the corrected NDVI values according to the generated corrected NDVI value calculation formula.

Such a configuration realizes a device and a method that enable calculation of NDVI values in which errors caused by the variations of sun-light reflection-vs-incidence angles are reduced.

### REFERENCE SIGNS LIST

10: Drone with a multispectral camera mounted

100: Image processing device

110: Image-capturing/information acquisition section

111: RED/NIR image-capturing section (camera)

112: Camera position and posture estimation section (GPS, etc.)

113: Clock section

114: Memory

120: Data processing section

121: NDVI calculation section

122: Sun position estimation section

123: Sun-light reflection-vs-incidence angle calculation section

124: NDVI correction section

125: NDVI corrected image generation section

130: Image display section

301: CPU

302: ROM

303: RAM

304: Bus

305: Input/output interface

306: Input unit

307: Output unit

308: Storage unit

309: Communication unit

310: Drive

311: Removable medium

1. An image processing device comprising:
a data processing section that retrieves an image captured by a camera and analyzes the retrieved image including a constituent pixel unit, to calculate a vegetation index that is associated with the constituent pixel unit and indicates an activity level of a plant,
wherein the data processing section calculates, on a basis of a sun-light incidence angle associated with the constituent pixel unit, a corrected value associated with the vegetation index and obtained by reducing a variation of the vegetation index caused by a variation of a sun-light reflection-vs-incidence angle.

2. The image processing device according to claim 1, wherein the vegetation index includes an NDVI (Normalized Difference Vegetation index) value.

3. The image processing device according to claim 2,
wherein the retrieved image includes plural constituent pixel units, and
the data processing section
selects plural sampling points from among the plural constituent pixel units of the retrieved image to calculate a sampling-point two-dimensional distribution approximation model formula that approximates a two-dimensional distribution of NDVI values and sun-light reflection-vs-incidence angles at the selected sampling points,
generates, on a basis of the calculated sampling-point two-dimensional distribution approximation model formula, a corrected NDVI value calculation formula for calculating corrected values obtained by reducing variations of the NDVI values caused by variations of the sun-light reflection-vs-incidence angles, and
calculates the corrected values according to the generated corrected NDVI value calculation formula.

4. The image processing device according to claim 1,
wherein the data processing section includes
a sun position estimation section that estimates a sun position at a time point of capturing the image, and
a sun-light reflection-vs-incidence angle calculation section that calculates a sun-light reflection-vs-incidence angle θsc associated with the constituent pixel unit of the image captured by the camera, by using the sun position estimated by the sun position estimation section.

5. The image processing device according to claim 1, wherein the sun-light reflection-vs-incidence angle calculation section calculates, as the sun-light reflection-vs-incidence angle θsc, a sum of an incidence angle and a reflection angle of sun light relative to a photographed subject associated with a constituent pixel of the image captured by the camera.

6. The image processing device according to claim 2,
wherein the data processing section includes
an NDVI calculation section that, without taking into consideration the sun-light reflection-vs-incidence angle, analyzes the image captured by the camera, to calculate the NDVI value, and generates an NDVI image by setting the NDVI value to individual pixels, and
an NDVI correction section that retrieves the NDVI image generated by the NDVI calculation section and calculates, on a basis of a sampling-point two-dimensional distribution approximation model formula, a corrected NDVI value obtained by reducing a variation of the NDVI value caused by the variation of the sun-light reflection-vs-incidence angle.

7. The image processing device according to claim 2, wherein the data processing section calculates, as the sampling-point two-dimensional distribution approximation model formula, a first-order equation that approximates a two-dimensional distribution of NDVI values and sun-light reflection-vs-incidence angles at the sampling points.

8. The image processing device according to claim 7, wherein the data processing section calculates coefficients of the first-order equation by using a regression straight line calculation method to which a least-square method is applied.

9. The image processing device according to claim 2, wherein the data processing section further includes an NDVI corrected image generation section that generates an NDVI corrected image including the corrected value.

10. The image processing device according to claim 9, wherein the NDVI corrected image generation section generates a combined image by performing stitch-processing on plural NDVI corrected images.

11. The image processing device according to claim 2, wherein the data processing section selects plural sampling points from among constituent pixels of plural images captured at mutually different timings and calculates a sampling-point two-dimensional distribution approximation model formula that approximates a two-dimensional distribution of NDVI values and sun-light reflection-vs-incidence angles at the selected sampling points.

12. The image processing device according to claim 2,
wherein the data processing section
determines whether or not a calculated sampling-point two-dimensional distribution approximation model formula is appropriate,
generates, on condition that it is determined that the calculated sampling-point two-dimensional distribution approximation model formula is appropriate, a corrected NDVI value calculation formula for calculating corrected values obtained by reducing variations of NDVI values caused by variations of sun-light reflection-vs-incidence angles, on a basis of the calculated sampling-point two-dimensional distribution approximation model formula, and
calculates the corrected values according to the generated corrected NDVI value calculation formula.

13. The image processing device according to claim 12, wherein the data processing section performs, as processing of determining whether or not the calculated sampling-point two-dimensional distribution approximation model formula is appropriate, processing of determining whether or not the calculated sampling-point two-dimensional distribution approximation model formula coincides with an existing theory indicating that the NDVI values decrease as influences of sun-light specular reflection increase.

14. The image processing device according to claim 2,
wherein the data processing section
calculates a sampling-point two-dimensional distribution approximation model formula associated with a kind of plant,
generates, on a basis of the calculated sampling-point two-dimensional distribution approximation model formula associated with the kind of plant, a corrected NDVI value calculation formula associated with the kind of plant, and
calculates a corrected value associated with the kind of plant according to the generated corrected NDVI value calculation formula associated with the kind of plant.

15. The image processing device according to claim 1, wherein the image captured by the camera includes an image captured by a multispectral camera capable of simultaneously capturing two images having mutually different wavelengths that include a RED wavelength (approximately 0.63 to 0.69 μm) and an NIR wavelength (approximately 0.76 to 0.90 μm).

16. The image processing device according to claim 1, wherein the image captured by the camera includes an image captured from sky.

17. An image processing method performed by an image processing device including a data processing section that retrieves an image captured by a camera and analyzes the retrieved image including a constituent pixel unit, to calculate a vegetation index that is associated with the constituent pixel unit and indicates an activity level of a plant, the method comprising:
causing the data processing section to calculate, on a basis of a sun-light incidence angle associated with the constituent pixel unit, a corrected value associated with the vegetation index and obtained by reducing a variation of the vegetation index caused by a variation of a sun-light reflection-vs-incidence angle.

18. A program that causes an image processing device to perform image processing, the image processing device including a data processing section that retrieves an image captured by a camera and analyzes the retrieved image including a constituent pixel unit, to calculate a vegetation index that is associated with the constituent pixel unit and indicates an activity level of a plant, the program causing the data processing section to perform:
processing of calculating, on a basis of a sun-light incidence angle associated with the constituent pixel unit, a corrected value associated with the vegetation index and obtained by reducing a variation of the vegetation index caused by a variation of a sun-light reflection-vs-incidence angle.
